(19) United States
(12) Patent Application Publication
(10) Pub. No.: US 2005/0196616 A1
(43) Pub. Date: Sep. 8, 2005

(54) Photochromic optical article

(76) Inventors: Kevin J. Stewart, Murrysville, PA (US); Kevin W. Seybert, Pittsburgh, PA (US)

Correspondence Address: Frank P. Mallak, One PPG Place, Pittsburgh, PA, 15272, US

(21) Appl. No.: 10/793,498

(22) Filed: Mar. 4, 2004

(51) Int. Cl. B32B 27/36; B32B 27/00

(52) U.S. Cl. 428/412; 428/423.1

(57) ABSTRACT

Describes a photochromic article, e.g., an ophthalmic photochromic article, such as a plastic lens, in which the article comprises, in combination, (1) a rigid substrate, such as a transparent thermoset or thermoplastic polymeric substrate, (2) a photochromic polymeric coating superposed on, e.g., appended to, at least one surface of the substrate, the photochromic polymeric coating containing a photochromic amount of at least one organic photochromic material, e.g., spirooxazine, naphthopyran and/or fulgide, (3) a film comprising a cross-linked polyhydroxy polymer, e.g., a poly(vinyl alcohol) polymer, appended to said photochromic polymeric coating, and (4) a further organic polymer layer that is superposed on said film comprising a cross-linked polyhydroxy polymer. Describes also the aforedescribed photochromic article having an abrasion-resistant coating affixed to the further organic polymer coating, e.g., an abrasion-resistant coating comprising an organo silane; and a photochromic article having an antireflective coating affixed to the abrasion-resistant coating.

### DESCRIPTION OF THE INVENTION

The present invention relates to photochromic articles comprising a rigid substrate to which is applied a photochromic polymeric coating on which is superposed a cross-linked polyhydroxy polymer film. In particular, the present invention relates to transparent rigid substrates, e.g., glass and organic plastic substrates used for optical applications. More particularly, the present invention relates to photochromic articles used for ophthalmic applications, e.g., lenses. Still more particularly, the present invention relates to photochromic articles comprising a transparent rigid polymeric substrate having a transparent photochromic organic polymeric coating superposed on at least a portion of at least one surface of the substrate and a transparent cross-linked polyhydroxy polymer film that is superposed, e.g., appended to, the photochromic organic polymeric coating. In a further embodiment, a transparent further organic polymer layer is superposed on the polyhydroxy polymer film.

The present invention relates further to the foregoing photochromic article in which an abrasion resistant coating is superposed on, e.g., appended to, the layer of the transparent further organic polymer, and optionally in which an antireflective coating is superposed on, e.g., appended to, the abrasion resistant coating. In a contemplated embodiment, the further transparent polymer layer is not photochromic. The further transparent polymer layer can have the abrasion resistant coating adjacent to it, and in turn the antireflective coating can be placed adjacent to the abrasion resistant coating. The further transparent polymer layer can be referred to as a tie layer because of its location between the polyhydroxy polymer film and the abrasion resistant coating, and because in one desirable contemplated embodiment, it ties together the cross-linked polyhydroxy polymer film and the abrasion resistant coating.

Still more particularly, the present invention relates to photochromic articles, such as an ophthalmic plastic lens, on at least a portion of at least one surface of which has been appended sequentially, a first layer of a transparent, desirably optically clear, photochromic polymeric coating, a second layer comprising a cross-linked polyhydroxy polymer film, and a further (or third) layer of a transparent organic polymer tie layer. In a further embodiment of the present invention, an abrasion resistant coating is appended to the further transparent organic polymer tie layer. In a still further embodiment of the present invention, there are contemplated photochromic articles having an additional layer comprising an antireflective coating that is applied to the abrasion resistant coating. At least one additional layer (coatings/films) can be applied to the antireflective coating or to the abrasion resistant coating in place of or below the antireflective coating to provide further functional properties to the photochromic article, e.g., antistatic, polarizing and/or anti-wetting coatings.

Clear ophthalmic articles that provide good imaging qualities while reducing the transmission of incident light into the eye are needed for a variety of applications, such as sunglasses, vision correcting ophthalmic lenses, plano lenses and fashion lenses, e.g., non-prescription and prescription lenses, sport masks, face shields, goggles, visors camera lenses, windows, automotive windshields and aircraft and automotive transparencies, e.g., T-roofs, sidelights and backlights. Responsive to that need, photochromic plastic articles used for optical applications have been given considerable attention. In particular, photochromic ophthalmic plastic lenses have been of interest because of the weight advantage they offer, vis-à-vis, glass lenses.

In addition, embodiments of the present invention can be used in association with plastic films and sheets, optical devices, e.g., optical switches, display devices and memory storage devices, such as those described in U.S. Pat. No. 6,589,452, and security elements, such as optically-readable data media, e.g., those described in U.S. patent application 2002/0142248, security elements in the form of threads or strips, as described in U.S. Pat. No. 6,474,695, and security elements in the form of verification marks that can be placed on security documents and articles of manufacture.

Photochromism is a phenomenon involving a reversible change in color of an organic or inorganic material, e.g., a chromene or silver halide salt, or an article comprising such a material, upon exposure to ultraviolet radiation. Sources of radiation that contain ultraviolet rays include, for example, sunlight and the light of a mercury lamp. When the photochromic material is exposed to ultraviolet radiation, it exhibits a change in color, and when the ultraviolet radiation is discontinued, the photochromic material returns to its original color or colorless state. Ophthalmic articles that have photochromic material(s) applied to or incorporated within the article exhibit this reversible change in color and a consequent reversible change in light transmission.

The mechanism believed to be responsible for this reversible change in color, e.g., the change in the absorption spectrum in the electromagnetic spectrum of visible light (400-700 nm), that is characteristic of different types of organic photochromic compounds has been described. See, for example, John C. Crano, “Chromogenic Materials (Photochromic)”, Kirk-Othmer Encyclopedia of Chemical Technology, fourth Edition, 1993, pp. 321-332. The mechanism responsible for the reversible change in color for organic photochromic compounds, such as indolino spiropyrans and indolino spirooxazines, is believed to involve an electrocyclic mechanism. When exposed to activating ultraviolet radiation, these organic photochromic compounds transform from a colorless closed ring form into a colored open ring form. In contrast, the electrocyclic mechanism responsible for the reversible change in color of photochromic fulgide compounds is believed to involve a transformation from a colorless open ring form into a colored closed ring form.

Photochromic plastic articles have been prepared by incorporating the photochromic material into the plastic substrate by surface imbibition techniques. In this method, photochromic dyes are incorporated into the subsurface region of a plastic article, such as a lens, by first applying one or more photochromic dyes/compounds to the surface of the plastic article, either as the neat photochromic dye/compound or dissolved in a polymeric or other organic solvent carrier, and then applying heat to the coated surface to cause the photochromic dye/compound(s) to diffuse into the subsurface region of the plastic article (a process commonly referred to as “imbibition”). The plastic substrates of such photochromic plastic articles are considered to have sufficient free volume within the polymer matrix to allow photochromic compounds, such as the aforementioned spirooxazines, spiropyrans and fulgides, to transform from the colorless form into the colored form, and then revert to their original colorless form.

There are, however, certain polymer matrices that are considered not to have sufficient free volume to allow the aforedescribed electrocyclic mechanism to occur sufficiently to permit their use as a substrate for imbibed (or internally incorporated) photochromic materials for commercially acceptable photochromic applications. Such substrates include, for example, thermoset polymer matrices, such as those prepared from polyol (allyl carbonate) monomers such as allyl diglycol carbonate monomers, e.g., diethylene glycol bis(allyl carbonate), and copolymers thereof, the commonly known thermoplastic bisphenol A-based polycarbonates, and highly cross-linked optical polymers.

To allow the use of thermoset polymers, thermoplastic polycarbonates, and highly cross-linked optical polymeric materials as plastic substrates for photochromic articles, it has been proposed to apply organic photochromic coatings to the surface of such plastic substrates. It has also been proposed to apply an abrasion-resistant coating onto the exposed surface of the photochromic coating to protect the surface of the photochromic coating from scratches and other similar cosmetic defects resulting from physical handling, cleaning and exposure of the photochromic coating to the environment.

In certain circumstances involving ophthalmic plastic lenses having a photochromic polymeric coating, it has been observed that the photochromic material within the polymeric coating migrates out of the polymeric coating and into an adjacent superposed layer placed on top of the photochromic polymeric coating. In some instances, the superposed layer is an abrasion resistant coating, while in other instances the superposed layer is the aforedescribed organic polymer tie layer.

It has now been discovered that superposing a cross-linked polyhydroxy polymer film on the photochromic polymeric coating can substantially attenuate the problem of photochromic migration.

In accordance with a particular embodiment of the present invention, there is contemplated a photochromic article, e.g., a lens, comprising, in combination:

(a) a rigid transparent substrate;

(b) a transparent organic polymeric coating superposed on at least a portion of at least one surface of said polymeric substrate, said polymeric coating comprising at least one organic photochromic material;

(c) a transparent cross-linked polyhydroxy polymer film superposed on said photochromic polymeric coating; and

(d) a transparent further organic polymer layer superposed on said cross-linked polyhydroxy polymeric film.

In another embodiment of the present invention, there is contemplated the above-described transparent photochromic article further comprising an abrasion-resistant coating, such as a hard coating comprising an organo silane, that is appended to the exposed surface of the further organic polymer layer (d). In yet other embodiments of the present invention, an antireflective coating is applied to the abrasion-resistant coating of the previously described embodiments. Other coatings, such as antistatic and/or antiwetting coatings can also be applied to or under the antireflective coating.

In a still further embodiment of the present invention, there is contemplated an ophthalmic photochromic article, e.g., a lens, comprising, in combination:

(a) a transparent organic plastic substrate, such as a rigid thermoset substrate prepared from a polymerizable composition comprising an allyl diglycol carbonate, such as diethylene glycol bis(allyl carbonate), a substrate prepared from thermoplastic polycarbonate, a substrate prepared from a polyurea urethane, or a substrate prepared from compositions comprising the reaction product of polyfunctional isocyanate(s) and/or isothiocyanate(s) with polythiol(s) or polyepisulfide monomer(s);

(b) an optically clear organic polymeric photochromic coating, such as an acrylic-based, polyurethane-based, polyurea urethane-based, aminoplast resin-based, or polyepoxy-based photochromic coating, appended to at least a portion of at least one surface of said plastic substrate, said polymeric photochromic coating comprising a photochromic amount of at least one organic photochromic material;

(c) a film of a transparent cross-linked polyhydroxy polymer, such as a cross-linked polyvinyl alcohol, appended to said photochromic organic polymeric coating;

(d) an optically clear, organic polymer tie layer, e.g., coating or film, adhered coherently to said cross-linked polyhydroxy polymer film; and

(e) optionally an abrasion resistant coating, such as an organo silane-containing hard coating, adhered to said organic polymer tie layer (d). In yet a further contemplated embodiment, an antireflective coating is adhered to said abrasion-resistant coating, assuming that the abrasion-resistant coating is present.

### DETAILED DESCRIPTION OF THE INVENTION

In accordance with an embodiment of the present invention, there is provided a photochromic article comprising, in combination, (1) a rigid substrate, e.g., a transparent substrate such as glass or an organic polymeric material, (2) a photochromic polymeric coating superposed on, e.g., affixed to, at least a portion of at least one surface of the rigid substrate, the photochromic polymeric coating comprising a photochromic amount of at least one photochromic material, e.g., dye or compound, (3) a transparent cross-linked polyhydroxy polymer film superposed, e.g., appended to, the photochromic polymeric coating, and (4) an organic polymer tie layer (film/coating) superposed on, e.g., appended to, the cross-linked polyhydroxy polymer film. In a further embodiment of the present invention, an abrasion resistant coating, e.g., an organo silane hard coating, is applied to the organic polymer tie layer. In a still further contemplated embodiment, additional coatings are applied to the abrasion resistant coating. Such additional coatings can include, but are not limited to,. antireflective coatings, antistatic coatings, water repellant coatings and combinations of such coatings.

For purposes of this specification (other than in the operating examples), unless otherwise indicated, all numbers expressing quantities and ranges of ingredients, reaction conditions, etc., such as those expressing refractive indices and wavelengths, are to be understood as modified in all instances by the term “about”. Accordingly, unless indicated to the contrary, the numerical parameters set forth in this specification and attached claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Further, as used in this specification and the appended claims, the singular forms “a”, “an” and “the” are intended to include plural referents, unless expressly and unequivocally limited to one referent.

As used herein, the term “cure”, “cured” or similar terms, as used in connection with a cured or curable composition, e.g., a “cured composition” of some specific description is intended to mean that at least a portion of the polymerizable and/or crosslinkable components that form the curable composition are at least partially polymerized and/or cross-linked. In certain embodiments, the crosslink density of the crosslinkable components, e.g., the degree of crosslinking, can range from 5% to 100% of complete crosslinking. In other embodiments, the crosslink density can range from 35% to 85%, e.g., 50 to 85%, of full crosslinking. The degree of crosslinking can range between any combination of the previously stated values, inclusive of the recited values.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The specific citation in this specification of patent applications, published or granted patents and published articles, such as the disclosures in identified patents that are referred to by column and line number, which describe relevant methods for preparing monomers, polymerizates, coatings, articles of manufacture, photochromic compounds, etc. are incorporated herein, in toto, by reference.

In accordance with the present invention, a film of cross-linked polyhydroxy polymeric material is superposed, e.g., superimposed, on the photochromic polymeric coating. Polyhydroxy polymers used as the source of the film are available commercially and can be natural materials, chemically modified natural materials, and/or synthetic materials.

Among the natural materials that can be used are the natural water-soluble resins, such as agar (CAS 9002-18-0), carragenan (CAS 9000-07-1), guar gum (CAS 9000-30-0), gum arabic (CAS 9000-01-5), gum karaya (CAS 9000-36-6), locust bean gum (CAS 9000-40-2), gum traganth (CAS 9000-65-1), polysaccharides, such as potato, wheat, and rice starches (CAS 9005-25-8), tapioca (CAS 9005-25-8), corn starch (9005-25-8), and cellulose. Chemically modified natural materials include cellulose derivatives such as methyl cellulose (CAS 9004-67-5), sodium carboxy methyl cellulose (CAS 9004-32-4), hydroxyalkyl cellulose, such as hydroxyethyl and hydroxypropyl cellulose (CAS 9004-62-0 and 9004-64-2), cationic starch, e.g., aminoalkyl starch (CAS 9043-45-2), dextran (CAS 9004-54-0) and xanthan gum (CAS 11138-66-2).

Among the synthetic polyhydroxy polymers that can be used, there can be mentioned polymers prepared from hydroxy-containing ethylenic monomers, such as 2-hydroxyethyl methacrylate, 2-hydroxypropyl acrylate, 2-hydroxypropyl methacrylate, 2,4-dihydroxy-4-vinyl benzophenone, N-2-hydroxyethyl acrylamide, N-2-hydroxyethyl methacrylamide, and polyvinyl alcohols (CAS 9002-89-5), which are prepared by hydrolysis of poly(vinyl acetate). Polyvinyl alcohols are commercially available and are typically used as the film that is superposed on the photochromic polymeric coating. Commercially, and as used in this description and the accompanying claims, the term “poly(vinyl alcohol)” includes all water-soluble resins made from poly(vinyl acetate). Among the commercial poly(vinyl alcohols), there can be mentioned those materials available under the trademarks ELVANOL, VINOL, GELVATOL and CELVOL.

A wide range of grades of poly(vinyl alcohols) are available commercially and include grades that are a fully hydrolyzed form of poly(vinyl acetate) and grades containing residual, e.g., unhydrolyzed acetate groups. There are three commercially significant types of poly(vinyl alcohol) [PVA] and these types are distinguished by the mole percent of residual (unhydrolyzed) acetate groups in the resin, e.g., fully hydrolyzed (1-2 mole percent), intermediate hydrolyzed (3-7 mole percent), and partially hydrolyzed (10- 15 mole percent). PVAs with other degrees of hydrolysis are commercially available, but are not as commercially significant.

The physical properties of poly(vinyl alcohols) will vary according to the molecular weight of the parent poly(vinyl acetate) and the degree of hydrolysis. The degree of hydrolysis typically ranges from 72 to 98 or 99.8%. Desirably, the degree of hydrolysis for the PVA is at least 87%. The degree of hydrolysis affects the temperature required to solubilize PVA in water. Lower temperatures are required as the degree of hydrolysis is decreased. A hydrolysis range of 87-89% is considered optimum for both cold and hot water solubility. The weight average molecular weight of poly(vinyl alcohols) can range from 3,000 to 190,000, more particularly, from 30,000 to 150,000, e.g., from 80,000 to 120,000.

Plasticizers can be added to poly(vinyl alcohol) in amounts up to 10 percent, e.g., from 1 to 7 percent. Water and polyhydroxy compounds, e.g., high boiling water-soluble organic compounds containing hydroxyl groups, are typically used as plasticizers for PVA films. Polyhydroxy compounds that can be used as a plasticizer include, but are not limited to, glycerol, ethylene glycol, poly(ethylene glycols) such as diethylene glycol and triethylene glycol, trimethylene glycol, tetramethylene glycol, pentamethylene glycol and hexamethylene glycol, propylene glycol, 2,3-butanediol, 1,3-butanediol, 2,2-dimethyl-1,3-butanediol, sorbitol, methylolated cyclic ethylene urea, and high boiling methylol compounds, such a pentaerythritol and 1,2,6-hexanetriol.

Crosslinking of poly(vinyl alcohols) insolubilizes and improves the water resistance and the mechanical properties of the PVA. Typically, bifunctional compounds that react with hydroxyl groups are used as crosslinking materials. Crosslinking materials that can be used include, but are not limited to, dimethylol urea, trimethylol melamine, low molecular weight dialdehydes, such as glyoxal and glutaraldehyde, urea-formaldehydes, melamine-formaldehydes, oxalic acid, diepoxides, polyacrolein, dialdehyde starch, divinyl sulfone, diisocyanates and organic titanates. Crosslinking of PVA can also be obtained when the parent poly(vinyl acetate) is cross-linked by irradiation and subsequently hydrolyzed. An acid catalyst, e.g., ammonium sulfate or ammonium chloride, is typically used with formaldehyde crosslinking materials.

Poly(vinyl alcohol) films and cross-linked PVA films are generally clear and transparent. The films are typically tough and have high tensile strength and abrasion resistance. Poly(vinyl alcohol) films and films from other synthetic, natural and chemically modified natural polyhydroxy polymers can be produced by solution casting or extrusion; however, film casting is most commonly used.

The cross-linked polyhydroxy polymer film can be applied to the photochromic polymeric coating by any convenient means. Non-limiting examples of such methods include preparing an aqueous solution comprising the polymer and cross-linking agent, applying the composition to the surface of the photochromic polymeric coating and curing the polyhydroxy polymer composition; and pre-forming a film of the cross-linked polyhydroxy polymer and applying the pre-formed film to the photochromic polymeric coating.

The aqueous composition comprising the polyhydroxy polymer and cross-linking agent is applied in a manner to obtain a substantially uniform and homogenous film. The thickness of the film can vary. Generally, the film thickness can vary from 0.1 micron, desirably at least 0.5 micron, more desirably, at least 1 micron, to a thickness of not more than 50 microns, desirably not more than 25 microns, and most desirably not more than 10 microns. The thickness of the cross-linked polyhydroxy film can range between any combinations of these values, inclusive of the recited values. For example, the cross-linked polyhydroxy film can range from 0.1 to 10 microns.

Prior to applying the cross-linked polyhydroxy film to the photochromic polymeric coating, the photochromic coating can be treated to enhance adhesion of the polyhydroxy film to it. Non-limiting examples of such treatments include UV treatment, activated gas treatment, e.g., treatment with low temperature plasma or corona discharge, and chemical treatment that results in hydroxylation of the surface of the photochromic coating are discussed later herein with respect to treatment of the rigid substrate, e.g., the organic polymer substrate, and that discussion is incorporated here.

Rigid substrates to which the photochromic polymeric coating are applied can vary and include any rigid substrate that will support a photochromic polymeric coating. Non-limiting examples of such rigid substrates include: paper, glass, ceramics, wood masonry, textiles, metals and organic polymeric materials. The particular substrate used will depend on the particular application that requires both a rigid substrate and a photochromic coating, which photochromic coating further requires the protection of a cross-linked polyhydroxy film adjacent to the photochromic coating. In a desired embodiment, the rigid substrate is transparent. Polymeric substrates that can be used in preparing the photochromic articles of the present invention include organic polymeric materials and inorganic materials, such as glass. As used herein, the term “glass” is defined as being a polymeric substance, e.g., a polymeric silicate. Glass substrates can be of any type suitable for the intended purpose; but, are desirably a clear, low colored, transparent glass such as the well-known silica type of glass, particularly soda-lime-silica glass. The nature and composition of various silica glasses are well known in the art. The glass can be strengthened by either thermal or chemical tempering.

Polymeric organic substrates that can be used in preparing the photochromic articles of the present invention, are any of the currently known (or later discovered) plastic materials that are chemically compatible with the photochromic polymeric coating superposed on, e.g., applied to, the surface of the substrate. Particularly contemplated are the art-recognized polymers that are useful as optical substrates, e.g., organic optical resins that are used to prepare optically clear castings for optical applications, such as ophthalmic lenses.

Non limiting examples of organic substrates that can be used as polymeric organic substrates are polymers, e.g., homopolymers, oligomers and copolymers, prepared from the monomers and mixtures of monomers disclosed in U.S. Pat. No. 5,962,617 and from column 15, line 28 to column 16, line 17 of U.S. Pat. No. 5,658,501. Such organic substrates can be thermoplastic or thermoset polymeric substrates, e.g., transparent, more particularly, optically clear, substrates having a refractive index that desirably ranges from 1.48 to 1.74, e.g., 1.50 to 1.67.

Non-limiting examples of such disclosed monomers and polymers include: polyol(allyl carbonate) monomers, e.g., allyl diglycol carbonates such as diethylene glycol bis(allyl carbonate), which monomer is sold under the trademark CR-39 by PPG Industries, Inc; polyurea-polyurethane (polyurea urethane) polymers, which are prepared, for example, by the reaction of a polyurethane prepolymer and a diamine curing agent, a composition for one such polymer being sold under the trademark TRIVEX by PPG Industries, Inc; polyol(meth)acryloyl terminated carbonate monomer; diethylene glycol dimethacrylate monomers; ethoxylated phenol methacrylate monomers; diisopropenyl benzene monomers; ethoxylated trimethylol propane triacrylate monomers; ethylene glycol bismethacrylate monomers; poly(ethylene glycol) bismethacrylate monomers; urethane acrylate monomers; poly(ethoxylated bisphenol A dimethacrylate); poly(vinyl acetate); poly(vinyl alcohol); poly(vinyl chloride); poly(vinylidene chloride); polyethylene; polypropylene; polyurethanes; polythiourethanes; thermoplastic polycarbonates, such as the carbonate-linked resin derived from bisphenol A and phosgene, one such material being sold under the trademark LEXAN; polyesters, such as the material sold under the trademark MYLAR; poly(ethylene terephthalate); polyvinyl butyral; poly(methyl methacrylate), such as the material sold under the trademark PLEXIGLAS, polymers prepared by reacting polyfunctional isocyanate(s) and/or isothiocyanate(s) with polythiol(s) or polyepisulfide monomers, either homopolymerized or co-and/or terpolymerized with polythiols, polyisocyanates, polyisothiocyanates and optionally ethylenically unsaturated monomers or halogenated aromatic-containing vinyl monomers, and other high index polymers. Also contemplated are copolymers of such monomers and blends of the described polymers and copolymers with other polymers, e.g., to form interpenetrating network products. The exact nature of the organic substrate is not critical to the present invention. However, the organic polymeric substrate should be chemically compatible with the photochromic polymeric coating superposed on, e.g., applied to, the surface of the substrate. For optical applications, the substrate should be transparent, more desirably optically clear.

The polymeric organic substrate used to prepare the photochromic articles of the present invention can have a protective coating, e.g., an abrasion resistant coating, on its surface. For example, commercially available thermoplastic polycarbonate optical lenses are typically sold with an abrasion-resistant coating, e.g., a hard coating, already applied to its surface(s) because the surface tends to be readily scratched, abraded or scuffed. An example of such an article is the Gentex polycarbonate lens (available from Gentex Optics) that is sold with a hard coating already applied to the polycarbonate surface. As used in this disclosure and claims, the terms “polymeric organic substrate” (or similar terms) or “surface” of such a substrate, is intended to mean and include either the polymeric organic substrate itself or such a substrate with a coating, e.g., protective coating and/or primer, on the substrate. Thus, when reference is made in this disclosure or claims to applying a primer coating or photochromic polymeric coating to the surface of the substrate, such reference includes applying such a coating to the polymeric organic substrate per se or to a coating, e.g., an abrasion-resistant coating or primer, on the surface of the substrate. Hence, the term “substrate” includes substrates having a protective coating and/or primer on its surface. The coating can be any suitable coating (other than a photochromic coating) and is not limited to an abrasion-resistant coating (hard coat), e.g., any protective coating, primer coating or even a coating that provides additional functional properties to the article of which the substrate is a part.

The use of photochromic organic coatings on plastic substrates, particularly plastic substrates such as thermoplastic polycarbonates, has been described. Any organic polymeric material that is compatible with the chosen organic substrate and which will function as a host material for the organic photochromic materials or compounds chosen for use can be used as the material for the photochromic organic coating. Desirably, the host organic polymeric coating has sufficient internal free volume for the photochromic material to function efficiently, e.g., to change from a colorless form to a colored form that is visible to the naked eye in response to ultraviolet (UV) radiation, and to change back to the colorless form when the UV radiation is removed. Otherwise, the precise chemical nature of the organic coating that is used as the host material for the photochromic material(s) is not critical.

Non-limiting examples of such organic polymeric materials include polyurethane-based coatings, such as those described in U.S. Pat. Nos. 6,107,395 and 6,187,444 B1, and International Publication WO 01/55269; polyurea urethane-based coatings as those described from column 2, line 27 to column 18, line 67 in U.S. Pat. No. 6,531,076B2; epoxy resin-based coatings, such as those described in U.S. Pat. No. 6,268,055 B1; acrylic/methacrylic monomer-based coatings, such as those described in U.S. Pat. No. 6,602,603; International Patent Publications WO 96/37593 and WO 97/06944, and U.S. Pat. Nos. 5,621,017 and 5,776,376; aminoplast, e.g., melamine type, resins, such as those described in U.S. Pat. Nos. 6,506,488 B1 and 6,432,544 B1; coatings comprising hydroxyl-functional components and polymeric anhydride-functional components, e.g., polyanhydride coatings, such as those described in U.S. Pat. No. 6,436,525 B1; and coatings comprising N-alkoxymethyl(meth)acrylamide functional polymers, such as those described in U.S. Pat. No. 6,060,001.

Of particular interest are photochromic polyurethane-based coatings, photochromic polyacrylic or polymethacrylic-based coatings [referred to collectively herein as poly(meth)acrylic-based coatings], photochromic polyurea urethane-based coatings, photochromic aminoplast resin-based coatings and photochromic epoxy resin-based coatings. Of special interest are the optically clear photochromic polyurethane, epoxy and poly(meth)acrylic-based coatings for use on transparent, e.g., optically clear, plastic substrates for ophthalmic applications, such as plano and vision correcting lenses, sun lenses and goggles, commercial and residential windows, automotive and aircraft transparencies, helmets, plastic sheeting, clear films, etc.

The term “transparent”, as used in this disclosure and claims in connection with a substrate, film or coating, is intended to mean that the indicated coating, film or material, such as the plastic substrate, the non-activated photochromic polymeric coating, the polymeric tie layer, and coatings superimposed or superposed on the photochromic polymeric coating or polymeric tie layer, have a light transmission of at least 70%, desirably at least 80%, and more desirably at least 85%. By the term “optically clear”, as used in this disclosure and claims, is meant that the specified item has a light transmission that satisfies commercially accepted and regulatory values for optical, e.g., ophthalmic, articles.

Polyurethanes that can be used to prepare a photochromic polyurethane coating are those produced by the reaction of an organic polyol component and an isocyanate component, as more fully described in column 3, line 4 through column 6, line 22 of U.S. Pat. No. 6,187,444 B1. More particularly, the polyurethanes are produced from a combination of at least one hard segment producing organic polyol and at least one soft segment producing organic polyol. The weight ratio of hard segment producing polyols to soft segment-producing polyols can vary from 10:90 to 90:10.

The relative amounts of the components comprising the polyurethane reaction mixture can be expressed as a ratio of the available number of reactive isocyanate groups to the available number of reactive hydroxyl groups, e.g., a ratio of NCO:OH groups of from 0.3:1.0 to 3.0:1.0. The isocyanate component can be an aliphatic, aromatic, cycloaliphatic or heterocyclic isocyanate, or mixtures of such isocyanates. Typically, the isocyanate component is chosen from blocked or unblocked aliphatic or cycloaliphatic isocyanates, or mixtures of such isocyanates.

As further described in U.S. Pat. No. 6,107,395, polyurethanes suitable as a photochromic host material can be prepared from an isocyanate reactive mixture comprising (i) from 40 to 85 weight percent of one or more polyols having a nominal functionality of from 2 to 4 and molecular weights of from 500 to 6000 g/mole, (ii) from 15 to 60 weight percent of one or more diols or triols or mixtures thereof having a functionality of from 2 to 3 and molecular weights of from 62 to 499, and (iii) an aliphatic polyisocyanate having a functionality of less than 3, e.g., 2.

The previously mentioned U.S. Pat. No. 6,602,603 describes reaction mixtures for poly(meth)acrylic host materials for photochromic materials as comprising at least two difunctional (meth)acrylate monomers, which can have from greater than 3 to less than 15 alkoxy units. In one embodiment, a difunctional (meth)acrylate has the reactive acrylate groups connected by a straight or branched chain alkylene group, which usually contains from 1 to 8 carbon atoms; while a second difunctional (meth)acrylate has the reactive acrylate groups connected by ethylene oxide, propylene oxide, butylene oxide or mixtures of such oxide groups in random or block order.

Epoxy resin-based coatings described in U.S. Pat. No. 6,268,055 B1 are those prepared by the reaction of a composition comprising an epoxy resin or polyepoxide, e.g., polyglycidyl ethers of aliphatic alcohols and phenols, epoxy-containing acrylic polymers, polyglycidyl esters of polycarboxylic acids and mixtures of such epoxy-containing materials, with a curing agent, e.g., a polyacid comprising a half-ester formed from reacting an acid anhydride with an organic polyol.

Aminoplast resin-based coatings are described in U.S. Pat. Nos. 6,432,544 B1 and 6,506,488. These coatings are the reaction product of material(s) having at least two different functional groups chosen from hydroxyl, carbamate, urea or mixtures of such functional groups, and an aminoplast resin, e.g., a crosslinking agent. Materials having at least two different functional groups are described in the '444 patent from column 3, line 40 through column 12, line 23, and in the preceding disclosure with respect to the aminoplast tie layer. The aminoplast resin is a condensation product of an amine or amide with an aldehyde, e.g., formaldehyde, acetaldehyde, crotonaldehyde, benzaldehyde and furfural. The amine or amide can be melamine, benzoguanamine, glycoluril, urea and similar compounds. Melamine is typically used. Typically, the aminoplast resin has at least two reactive groups. Non-limiting examples of aminoplast resins are described in the '444 patent in column 12, lines 49 to 67.

The amount of photochromic polymeric coating applied to at least one surface of the plastic substrate is an amount that is sufficient to provide a sufficient quantity of organic photochromic material, which produces a coating that exhibits a desired change in optical density (ΔOD) when the cured coating is exposed to ultraviolet (UV) radiation, e.g., a photochromic amount. Desirably, the change in optical density measured at 22° C. (72° F.) after 30 seconds of UV exposure is at least 0.05, more desirably at least 0.15, and still more desirably at least 0.20. The change in optical density after 15 minutes of UV exposure is desirably at least 0.10, more desirably at least 0.50, and still more desirably at least 0.70.

Stated differently, the amount of active photochromic material used in the photochromic coating can range from 0.5 to 40.0 weight percent, based on the total weight of monomer(s)/resin(s) used to produce the coating. The relative amounts of photochromic material(s) used will vary and depend in part upon the relative intensities of the color of the activated form of the photochromic compound(s), the ultimate color desired, and the solubility or dispersibility of the photochromic material(s) in the polymeric coating. Desirably, the concentration of active photochromic material(s) within the photochromic coating ranges from 1.0 to 30 weight percent, more desirably, from 3 to 20 weight percent, and most desirably, from 3 to 10 weight percent (based on the total weight of monomer(s) used to produce the coating.) The amount of photochromic material in the coating can range between any combinations of these values, inclusive of the recited values.

The bleach rate of the photochromic coating, as reported in terms of the fading half-life (T ½), is desirably not more than 500 seconds, more desirably not more than 190 seconds, still more desirably not more than 115 seconds, and even more desirably not more than 50 seconds. The half-life bleach rate is the time interval in seconds for the change in optical density (ΔOD) of the activated form of the photochromic coating to reach one half the highest ΔOD after removal of the source of activating light. The aforedescribed values for change in optical density and bleach rate are measured at 22° C. (72° F.).

The photochromic coating applied to the surface of the rigid substrate will typically have a thickness of at least 3 microns, desirably at least 5 microns, more desirably, at least 10 microns, e.g., 20 or 30 microns. The applied photochromic coating will also usually have a thickness of not more than 200 microns, desirably not more than 100 microns, and most desirably not more than 50 microns, e.g., 40 microns. The thickness of the photochromic coating can range between any combinations of these values, inclusive of the recited values. For example, the photochromic coating can range from 10 to 50 microns, e.g., 20 to 40 microns. Desirably the applied photochromic coating is free of cosmetic defects, such as scratches, pits, spots, cracks, inclusions, etc.

Typically, the term “coating” is considered by those knowledgeable in the coating art to be a layer having a thickness of not more than 4 mils (about 100 microns). However, as used in this specification and claims in relation to the photochromic coating, the term coating is defined herein as having a thickness such as a thickness defined hereinabove. Further, as used in this specification and claims, it is intended that the term “surface of the polymeric substrate” or like terms, e.g., the surface to which the photochromic polymeric coating is applied, include the embodiment in which only at least a portion of the surface of the substrate is coated. Hence, the photochromic coating (and the polymeric tie layer that can be applied to the photochromic coating) can cover only a portion of a surface of the substrate, but typically it is applied to the entire surface of at least one surface.

The hardness of the photochromic coating is not critical, but after application and curing, should desirably be hard enough to be physically/mechanically handled without causing blemishes, e.g., scratches, in the coating. The hardness of the photochromic coating desirably is less than the organic polymer tie layer, which in turn is typically softer than the abrasion-resistant (hard coat) coating applied to the tie layer. Thus, the principal coatings applied to the rigid substrate (not including any primer layer that can be applied to the substrate) increase in hardness in the direction of the abrasion-resistant coating. The hardness of coatings or films can be quantified by tests known to the skilled artisan, e.g., Fischer microhardness, pencil hardness or Knoop hardness.

The Fischer microhardness of the photochromic polymeric coatings is typically less than 30 Newtons per mm2, more particularly, less than 25, e.g., less than 15, such as 2 or 5, Newtons per mm2. In particular, the Fischer microhardness values will be in the lower portion of the ranges described herein, e.g., from 2 to 25, such as 10 to 15, e.g., 12 Newtons per mm2. The lower range of hardness allows the electrocyclic mechanism discussed previously in relation to photochromic materials to occur with greater efficiency than at higher hardness values. The Fischer microhardness of the photochromic polymeric coatings can range between any combination of the stated values, inclusive of the recited values. Fischer microhardness values can be obtained with a Fischerscope HCV Model H-100 (available from Fischer Technology, Inc.) by taking 3 measurements in the center area of the test sample under conditions of a 100 milliNewton load, 30 load steps, and 0.5 second pauses between load steps at an indentor (Vickers diamond stylus)depth of 2 um(microns).

Photochromic materials, e.g., dyes/compounds or compositions containing such dye/compounds, that can be utilized for the photochromic coating applied to the substrate are inorganic and/or organic photochromic compounds and/or substances containing such organic photochromic compounds that are currently known to those skilled in the art or that are later discovered. The particular photochromic material(s), e.g., compound(s), chosen is not critical, and its/their selection will depend on the ultimate application and the color or hue desired for that application. When two or more photochromic compounds are used in combination, they are generally chosen to complement one another to produce a desired color or hue.

Organic photochromic compounds used in the photochromic coating commonly have at least one activated absorption maxima within the visible spectrum of between 300 and 1000, e.g., between 400 and 700, nanometers. The organic photochromic material(s) is incorporated, e.g., dissolved or dispersed, in the photochromic coating, and color when activated, e.g., when exposed to ultraviolet radiation, the photochromic material(s) changes to the color or hue that is characteristic of the colored form of such material(s).

The inorganic photochromic material typically contains crystallites of silver halide, cadmium halide and/or copper halide. Generally, the halide material is the chloride and bromide. Other inorganic photochromic materials can be prepared by the addition of europium (II) and/or cerium (III) to a mineral glass, such as a soda-silica glass. In one embodiment, the inorganic photochromic material(s) are added to molten glass and formed into particles that are incorporated into the coating composition that is used to form the polymeric photochromic coating. Such inorganic photochromic materials are described in the Kirk Othmer Encyclopedia of Chemical Technology, 4th Edition, Volume 6, pages 322 to 325.

In one contemplated embodiment, the organic photochromic component of the photochromic coating comprises:

(a) at least one photochromic organic compound having a visible lambda max of from 400 to less than 550, e.g., from 400 to 525, nanometers; and

(b) at least one photochromic organic compound having a visible lambda max of greater than 525 or 550 nanometers, e.g., from 525 or 550 to 700 nanometers.

Non-limiting examples of photochromic compounds that can be used in the photochromic coating include benzopyrans, naphthopyrans, e.g., naphtho[1,2-b]pyrans, naphtho[2,1-b]pyrans, spiro-9-fluoreno[1,2-b]pyrans, phenanthropyrans, quinopyrans, and indeno-fused naphthopyrans, such as those disclosed in U.S. Pat. No. 5,645,767 at column 1, line 10 to column 12, line 57 and in U.S. Pat. No. 5,658,501 at column 1, line 64 to column 13, line 36. Additional non-limiting examples of photochromic compounds that can be used include oxazines, such as benzoxazines, naphthoxazines, and spiro(indoline)pyridobenzoxazines. Other non-limiting examples of photochromic substances contemplated for use herein are photochromic metal dithizonates, e.g., mercury dithizonates, which are described in, for example, U.S. Pat. No. 3,361,706; fulgides and fulgimides, e.g. the 3-furyl and 3-thienyl fulgides and fulgimides, which are described in U.S. Pat. No. 4,931,220 at column 20, line 5 through column 21, line 38; diarylethenes, which are described in U.S. patent application 2003/0174560 from paragraph [0025] to [0086]; and mixtures of any of the aforementioned photochromic materials/compounds.

Further non-limiting examples of photochromic compounds, polymerizable photochromic compounds and complementary photochromic compounds are described in the following U.S. patents:

U.S. Pat. No. 5,166,345 at column 3, line 36 to column 14, line 3;

U.S. Pat. No. 5,236,958 at column 1, line 45 to column 6, line 65;

U.S. Pat. No. 5,252,742 at column 1, line 45 to column 6, line 65;

U.S. Pat. No. 5,359,085 at column 5, line 25 to column 19, line 55;

U.S. Pat. No. 5,488,119 at column 1, line 29 to column 7, line 65;

U.S. Pat. No. 5,821,287 at column 3, line 5 to column 11, line 39;

U.S. Pat. No. 6,113,814 at column 2, line 23 to column 23, line 29;

U.S. Pat. No. 6,153,126 at column 2, line 18 to column 8, line 60;

U.S. Pat. No. 6,296,785 at column 2 line 47 to column 31, line 5;

U.S. Pat. No. 6,348,604 at column 3, line 26 to column 17, line 15; and

U.S. Pat. No. 6,353,102 at column 1, line 62 to column 11, line 64.

Spiro(indoline)pyrans are also described in the text, Techniques in Chemistry, Volume III, “Photochromism”, Chapter 3, Glenn H. Brown, Editor, John Wiley and Sons, Inc., New York, 1971. In addition, it is contemplated that organic photochromic materials such as photochromic pigments and photochromic compounds encapsulated in metal oxides can be used in the photochromic coating. See, for example, the materials described in U.S. Pat. Nos. 4,166,043 and 4,367,170.

The photochromic coating can contain one photochromic compound or a mixture of two or more photochromic compounds, as desired. Mixtures of photochromic compounds can be used to attain certain activated colors such as a near neutral gray or near neutral brown. See, for example, U.S. Pat. No. 5,645,767, column 12, line 66 to column 13, line 19, which describes the parameters that define neutral gray and brown colors.

The photochromic compound(s) described herein can be incorporated into the curable coating composition by addition to the coating composition and/or by dissolving it in a solvent before adding it to the curable coating composition. Alternatively, although less desired, the photochromic compound(s) can be incorporated into the cured polymer coating by imbibition, permeation, diffusion or other transfer methods, which methods are known to those skilled in the art of dye transfer into host materials.

In addition to photochromic materials, the photochromic coating (or precursor formulation) can contain additional conventional adjuvants that impart desired properties or characteristics to the coating, or which are required by the process used to apply and cure the photochromic coating on the surface of the plastic substrate, or which enhance the performance of the coating. Such adjuvants include, but are not limited to, ultraviolet light absorbers, light stabilizers, such as hindered amine light stabilizers (HALS), asymmetric diaryloxalamide (oxanilide) compounds, singlet oxygen quenchers, e.g., a nickel ion complex with an organic ligand, antioxidants, e.g., polyphenolic antioxidants, heat stabilizers, rheology control agents, leveling agents, e.g., surfactants, free radical scavengers and adhesion promoting agents, such as trialkoxysilanes, e.g., silanes having an alkoxy radical of 1 to 4 carbon atoms, including γ-glycidoxypropyl trimethoxy silane, γ-aminopropyl trimethoxysilane, 3,4-epoxy cyclohexylethyl trimethoxysilane, dimethyldiethokysilane, aminoethyl trimethoxysilane, and 3-(trimethoxysilyl)propyl methacrylate. Mixtures of such photochromic performance enhancing adjuvant materials are also contemplated. See, for example, the materials described in U.S. Pat. Nos. 4,720,356, 5,391,327 and 5,770,115.

Compatible (chemically and color-wise) tints, e.g., dyes, can be added to the photochromic coating formulation or applied to the plastic substrate for medical reasons or for reasons of fashion, e.g., to achieve a more aesthetic result. The particular dye chosen can vary and will depend on the aforesaid need and result to be achieved. In one embodiment, the dye can be chosen to complement the color resulting from the activated photochromic materials used, e.g., to achieve a more neutral color or absorb a particular wavelength or incident light. In another contemplated embodiment, the dye can be chosen to provide a desired hue to the substrate and/or coating when the photochromic coating is in an inactivated state.

The photochromic coating composition can be applied to the surface of the substrate, e.g., the plastic substrate, as a polymerizable formulation and then cured (polymerized) by methods well known to those skilled in the art including, but not limited to, photopolymerization, thermal polymerization, infrared polymerization, and other sources of radiation. Such application methods include the art-recognized methods of spin coating, curtain coating, dip coating, spray coating or by methods used in preparing overlays. Such methods are described in U.S. Pat. No. 4,873,029.

When applied as a polymerizable formulation, the photochromic coating formulation will also typically contain from 0 to 10 weight percent, e.g., from 0.01 to 8 weight percent, desirably from 0.1 to 5 weight percent, based on the total weight of the polymerizable monomer(s) in the formulation, of at least one catalyst and/or polymerization initiator, including photoinitiators. The amount of catalyst/initiator can range between any combinations of the aforestated values, inclusive of the recited values. The catalyst(s)/initiator(s) will be chosen from those materials that can be used to polymerize the particular monomer(s) used to produce the polymeric coating chosen as the photochromic host, and that will not be significantly detrimental to the photochromic materials that can be included in the coating formulation. The amount of catalyst/polymerization initiator(s) used to polymerize the polymerizable components of the photochromic coating formulation can vary and will depend on the particular initiator and the polymerizable monomers used. Typically, only that amount that is required to initiate (catalyze) and sustain the polymerization reaction is required, e.g., an initiating or catalytic amount.

For example, catalysts that can be used to cure polyurethane reaction mixtures can be chosen from the group consisting of Lewis bases, Lewis acids and insertion catalysts described in Ullmann's Encyclopedia of Industrial Chemistry, 5^{th} Edition, 1992, Volume A21, pp. 673 to 674. Usually the catalyst is an organo tin catalyst, e.g., tin octylate, dibutyl tin dilaurate, dibutyl tin diacetate, dibutyl tin mercaptide, dibutyl tin dimaleate, dimethyl tin diacetate, dimethyl tin dilaurate and 1,4-diazabicyclo[2.2.2]octane. Mixtures of tin catalysts can be used. Other tin catalysts described in the art can be used as well.

Epoxy resin coating compositions typically contain a polyacid curing agent having a high average acid functionality, e.g., two or more acid groups per molecule. Desirably, the acid group is a carboxylic acid group. Non-limiting examples of polycarboxylic acids include dicarboxylic acids such as oxalic, malonic, succinic, tartaric, glutaric, adipic, sebacic, maleic, fumaric, phthalic, isophthalic, terephthalic, and dodecanedioc acids; tricarboxylic acids such as citric acid; and tetracarboxylic acids such as 1,2,3,4-butane tetracarboxylic acid.

Polyanhydride coating compositions typically contain an amine compound as the curing catalyst. Non-limiting examples of amine compounds include dimethyl cocoamine, dimethyl dodecylamine, triethylamine, triethanolamine and phenolic compounds containing at least two dialklyamino groups. Aminoplast resin and alkoxyacrylamide polymer coating compositions commonly contain an acidic material as a catalyst. Non-limiting examples include phosphoric acid or substituted phosphoric acids, such as alkyl acid phosphate and phenyl acid phosphate; and sulfonic acids or substituted sulfonic acids, such as para-toluene sulfonic acid, dodecylbenzene sulfonic acid and dinonylnaphthalene sulfonic acid.

Acrylic/methacrylic monomer-based coating compositions can contain thermal initiators, e.g., initiators that produce free radicals, such as organic peroxy compounds or azobis(organonitrile) compounds, photoinitiators or mixtures of such initiators.

Non-limiting examples of suitable organic peroxy compounds include peroxymonocarbonate esters, such as tertiarybutylperoxy isopropyl carbonate; peroxydicarbonate esters, such as di(2-ethylhexyl) peroxydicarbonate, di(secondary butyl) peroxydicarbonate and diisopropyl peroxydicarbonate; diacyl peroxides, such as 2,4-dichlorobenzoyl peroxide, isobutyryl peroxide, decanoyl peroxide, lauroyl peroxide, propionyl peroxide, acetyl peroxide, benzoyl peroxide, p-chlorobenzoyl peroxide; peroxyesters, such as t-butylperoxy pivalate, t-butylperoxy octylate, and t-butylperoxy isobutyrate; methylethylketone peroxide; and acetylcyclohexane sulfonyl peroxide.

Non-limiting examples of suitable azobis(organonitrile) compounds include azobis(isobutyronitrile), 2,2′-azobis(2,4-dimethylpentanenitrile), 1,1′-azobiscyclohexanecarbonitrile, and azobis(2,4-dimethylvaleronitrile) and mixtures of such azo thermal initiators. Desirably, the selected thermal initiators is one that does not discolor the resulting coating or decompose the photochromic material incorporated within the polymerizable coating composition.

Photopolymerization can be performed in the presence of at least one photoinitiator using ultraviolet light and/or visible light. Photoinitiators, which are free radical initiators, are classified in two major groups based upon their mode of action. Cleavage-type photoinitiators include acetophenones, α-aminoalkylphenones, benzoin ethers, benzoyl oximes, acylphosphine oxides and bisacylphosphine oxides. Abstraction-type photoinitiators include benzophenone, Michler's ketone, thioxanthone, anthraquinone, camphorquinone, fluorone and ketocoumarin. Abstraction-type photoinitiators function better in the presence of materials such as amines and other hydrogen donor materials added to provide labile hydrogen atoms for abstraction. Typical hydrogen donors have an active hydrogen positioned alpha to an oxygen or nitrogen, e.g., alcohols, ethers and tertiary amines, or an active hydrogen atom directly attached to sulfur, e.g., thiols. In the absence of such added materials, photoinitiation can still occur via hydrogen abstraction from monomers, oligomers or other components of the system.

Non-limiting examples of photopolymerization initiators which can be used include benzil, benzoin, benzoin methyl ether, benzoin isobutyl ether, benzophenol, acetophenone, benzophenone, 4,4′-dichlorobenzophenone, 4,4′-bis(N,N′-dimethylamino) benzophenone, diethoxyacetophenone, fluorones, e.g., the H-Nu series of initiators available from Spectra Group Limited, 2-hydroxy-2-methyl-1-phenylpropan-1-one, 1-hydroxycyclohexyl phenyl ketone, 2-isopropylthixantone, α-aminoalkylphenone, e.g., 2-benzyl-2-dimethylamino-1-(4-morpholinophenyl)-1-butanone, acylphosphine oxides, such as 2,6-dimethylbenzoyl diphenyl phosphine oxide, 2,4,6-trimethylbenzoyl diphenyl phosphine oxide, 2,6-dichlorobenzoyl diphenyl phosphine oxide, and 2,6-dimethoxybenzoyl diphenyl phosphine oxide, bisacylphosphine oxides, such as bis(2,6-dimethyoxybenzoyl)-2,4,4-trimethylepentyl phosphine oxide, bis(2,6-dimethylbenzoyl)-2,4,4-trimethylpentyl phosphine oxide, bis (2,4,6-trimethylbenzoyl)-2,4,4-trimethylpentyl phosphine oxide, and bis(2,6-dichlorobenzoyl)-2,4,4-trimethylpentyl phosphine oxide, phenyl-4-octyloxyphenyliodonium hexafluoroantimonate, dodecyldiphenyliodonium hexafluoroantimonate, (4-(2-tetradecanol)oxyphenyl)-iodonium hexafluoroantimonate and mixtures of such photopolymerization initiators.

The source of radiation used for photopolymerization is typically chosen from those sources that emit ultraviolet light and/or visible light. The source of radiation can be a mercury lamp, a mercury lamp doped with FeI₃ and/or GaI₃, a germicidal lamp, a xenon lamp, a tungsten lamp, a metal halide lamp or a combination of such lamps. Typically, the absorbance spectra of the photoinitiator(s) is matched with the spectral output of the light source bulb, e.g., an H bulb, D bulb, Q bulb and/or V bulb, for highest curing efficiency. The exposure time of the curable coating to the light source will vary depending upon the wavelength and intensity of the light source, the photoinitiator, and thickness of the coating. Generally, the exposure time will be sufficient to substantially cure the coating, or produce a coating that is cured sufficiently to allow physical handling followed by a post thermal cure. The photochromic coating can also be cured using an electron beam process that does not require the presence of a thermal or photoinitiator.

Solvents can also be present in the coating formulation in order to dissolve and/or disperse the components of the coating formulation. Typically, a solvating amount of solvent is used, e.g., an amount which is sufficient to solubilize/disperse the solid components in the coating formulation. Commonly, from 10 to 80 weight percent of solvent material, based on the total weight of the coating formulation, is used.

Examples of solvents include, but are not limited to, benzene, toluene, methyl ethyl ketone, methyl isobutyl ketone, acetone, ethanol, tetrahydrofurfuryl alcohol, propyl alcohol, propylene carbonate, N-methyl pyrrolidinone, N-vinyl pyrrolidinone, N-acetyl pyrrolidinone, N-hydroxymethyl pyrrolidinone, N-butyl pyrrolidinone, N-ethyl pyrrolidinone, N-(N-octyl)pyrrolidinone, N-(N-dodecyl)pyrrolidinone, 2-methoxyethyl ether, xylene, cyclohexane, 3-methyl cyclohexanone, ethyl acetate, butyl acetate, tetrahydrofuran, methanol, amyl propionate, methyl propionate, propylene glycol methyl ether, diethylene glycol monobutyl ether, dimethyl sulfoxide, dimethyl formamide, ethylene glycol, mono- and di-alkyl ethers of ethylene glycol and their derivatives, which are sold as CELLOSOLVE industrial solvents, and mixtures of such solvents.

In a further contemplated embodiment, the photochromic polymeric coating can be applied as a water-borne coating, e.g., as aqueous polymer dispersion, e.g., as a latex, with or without the presence of an organic solvent. This type of system is a two-phase system comprising an aqueous phase and an organic phase, which is dispersed in the aqueous phase. Use of water-borne coatings is well known in the art. See, for example, U.S. Pat. No. 5,728,769, which relates to aqueous urethane resins and coatings prepared from such resins, and the patents referred to in the '769 patent.

After the photochromic coating formulation is applied to the surface of the plastic substrate, it is cured (polymerized) by the application of heat (in the case of a thermal cure), and/or ultraviolet or electron beam radiation. The specific cure conditions used will depend on the plastic substrate, the polymerizable components in the formulation and the type of catalyst/initiator used, or in the case of electron beam radiation, the intensity of the electron beam. Thermal curing can involve heating from room temperature up to temperatures below which the plastic substrate is not damaged due to such heating. Temperatures up to 200° C. have been reported. Such cure conditions are well known in the art. For example, a typical thermal cure cycle involves heating the formulation from room temperature (22° C.) to from 85 to 125° C. over a period of from 2 to 20 minutes. The time required for ultraviolet or electron beam radiation cures is generally shorter than a thermal cure, e.g., from 5 seconds to 5 minutes, and will depend on the intensity (power) of the radiation. When the thermal or UV/electron beam cure conditions produce a coating that can be physically handled but is not completely cured, an additional thermal post cure step can also be employed to fully cure the photochromic coating.

Prior to applying the photochromic coating to the surface of the substrate to be covered, it is common to clean and treat that surface so as to enhance adhesion of the photochromic coating to the substrate. Non-limiting examples of cleansing methods include ultrasonic washing, washing with an aqueous soap/detergent solution (or washing with soap and water) followed by rinsing, and cleaning with an aqueous mixture of organic solvent, e.g., a 50:50 mixture of isopropanol/water or ethanol/water. Non-limiting examples of further treatments include UV treatment, activated gas treatment, e.g., treatment with low temperature plasma or corona discharge, and chemical treatment that results in hydroxylation of the substrate surface, e.g., etching of the surface with an aqueous solution of alkali metal hydroxide, e.g., sodium or potassium hydroxide, which solution can also contain a fluorosurfactant. Generally, the alkali metal hydroxide solution is a dilute aqueous solution, e.g., from 5 to 40 weight percent, more typically from 10 to 15 weight percent, such as 12 weight percent, alkali metal hydroxide. See, for example, U.S. Pat. No. 3,971,872, column 3, lines 13 to 25; U.S. Pat. No. 4,904,525, column 6, lines 10 to 48; and U.S. Pat. No. 5,104,692, column 13, lines 10 to 59, which describe surface treatments of polymeric organic materials.

A particularly desirable surface treatment is a low temperature plasma treatment. This method allows treatment of the surface to enhance adhesion of a superimposed film or coating, and is a clean and efficient way to alter the physical surface, e.g., by roughening and/or chemically altering the surface without affecting the rest of the article. Inert gases, such as. argon, and reactive gases, such as oxygen, have been used as the plasma gas. Inert gases will roughen the surface, while reactive gases such as oxygen will both roughen and chemically alter slightly the surface exposed to the plasma, e.g., by producing hydroxyl or carboxyl units on the surface. Oxygen is used desirably as the plasma gas because it is believed that it provides a slight, but effective, physical roughening of the surface along with a slight, but effective, chemical modification of the surface. Naturally, the extent of the surface roughening and/or chemical modification will be a function of the plasma gas and the operating conditions of the plasma unit (including the length of time of the treatment).

It is reported that a conventional plasma treatment alters the top 20 to 200 angstroms of the surface (a few molecular layers.) The operating conditions of the plasma unit are a function of the design and size, e.g., volume, of the plasma chamber, power and construction of the plasma unit. The frequency at which the plasma operates can vary, e.g., from a low frequency such as 40 kHz to microwave frequencies such as 2.45 GHz. Similarly, the power at which the plasma unit operates can vary, e.g., from 50 to 1000 Watts, e.g., 50 to 750, such as 50 to 150 Watts. The pressure at which the plasma unit operates can also vary; however, it has been observed that low pressures are generally less destructive physically of the treated surface, which is desired. Low pressures, e.g., from 20 to 65 or 70 Pa are believed to be useful. The time that the surface is exposed to the plasma can also vary and will be a function of the type of surface being treated, e.g., the type of polymer used for the photochromic polymeric coating. However, care should be taken that the surface is not treated for too long since lengthy periods of treatment can be counterproductive. One skilled in the art can readily determine the minimum time required to provide a plasma treated surface that enhances adhesion of the photochromic coating. For ophthalmic articles, such as lenses, the length of the plasma treatment will generally vary from 1 to 10 minutes, e.g., 1 to 5 minutes. One contemplated plasma treatment involves use of an oxygen plasma generated by a Plasmatech machine operating at a power level of 100 Watts for from 1 to 10, e.g., 1 to 5 minutes, while introducing 100 ml/minute of oxygen into the vacuum chamber of the Plasmatech machine.

In some cases, a primer coating is applied to the plastic surface substrate before application of the photochromic coating. The primer coating is interposed between the rigid, e.g., organic, substrate and the photochromic polymeric coating, and serves as a barrier coating to prevent interaction of the components comprising the photochromic polymeric coating with the substrate and vice versa, and/or as an adhesive layer to promote adhesion of the photochromic coating to the-plastic substrate. The primer can be applied to the rigid substrate by any of the methods used to apply the photochromic coating, e.g., spray, spin, spread, curtain, roll or dip coating; and can be applied to a cleaned and untreated or cleaned and treated, e.g., chemically treated, surface of the substrate. Primer coatings are well known to those skilled in the art. Selection of an appropriate primer coating will depend on the rigid substrate used and the particular photochromic coating, e.g., the primer coating must be chemically and physically compatible with the surface of the rigid substrate and the photochromic coating, while providing the functional benefits desired for the primer coating, e.g., barrier and adhesive properties.

The primer coating can be one or several monomolecular layers thick, and can range from 0.1 to 10 microns, more usually from 0.1 to 2 or 3 microns. The thickness of the primer can vary between any combination of the aforementioned values, inclusive of the recited values. One contemplated embodiment of a suitable primer coating comprises an organofunctional silane, such as methacryloxypropyl trimethoxysilane, a catalyst of a material that generates acid on exposure to actinic radiation, e.g., onium salts, and an organic solvent, such as diglyme or isopropyl alcohol, as described in U.S. Pat. No. 6,150,430. A further example of a primer coating is described in U.S. Pat. No. 6,025,026, which describes a composition that is substantially free of organosiloxanes and which comprises organic anhydrides having at least one ethylenic linkage and an isocyanate-containing material.

In a further contemplated embodiment, of the present invention, a further transparent polymer layer (coating or film), e.g., a tie layer, which typically is not photochromic, is superposed, e.g., superimposed on, the polyhydroxy polymer film. The further transparent polymer layer can have an abrasion resistant coating or other functional layer appended to it. The further polymer layer should be, as stated, transparent, e.g., optically clear, and not substantially interfere with the optical properties of an optical, e.g., ophthalmic, photochromic article prepared with the further transparent polymer layer. Further, the polymeric tie layer is desirably resistant to dilute aqueous inorganic caustic solutions, e.g., aqueous sodium and potassium hydroxide solutions, and is compatible with an abrasion resistant coating (if used) applied to the surface of the further organic polymer layer.

The precise chemical nature of the polymeric tie layer is not critical, with the proviso that it be transparent, e.g., optically clear. Any curable polymeric material that, when cured, is transparent and ties together the polyhydroxy polymer film and a superposed functional layer, e.g., the abrasion resistant coating or other film/coating that provides additional features, without adversely affecting the function of the functional layers that it ties together (including the photochromic coating), can be used as a tie layer. Other film/coatings that provide additional features include, but are not limited to, antireflective coatings, antistatic coatings, water repellant coatings and combinations of such coatings. A suitable polymeric tie layer is described in International Patent Application WO 03/058300. The tie layer described in said International Patent Application is a radiation cured acrylate-based tie layer and is described therein as being (a) scratch resistant, (b) resistant to treatment with dilute aqueous inorganic caustic solutions, and (c) compatible with abrasion resistant, organo silane-containing coatings.

Other materials that can be used as the further transparent organic polymeric layer (tie layer) include, but are not limited to, (1) dendritic polyester acrylate-based coating layers, as described in U.S. patent application Ser. No. ______ of E. King, which has been filed on the same date as the present application and is entitled “Photochromic Optical Article”; (2) cured coating layers prepared from compositions comprising a maleimide derivative, as described in U.S. patent application Ser. No. ______ of E. King, which has been filed on the same date as the present application and is entitled “Photochromic Optical Article”; (3) thermally cured acrylic-based coatings; and (4) thermally cured, crosslinkable thermosetting coating compositions, such as polyurethane-based coatings, polyepoxide-based coatings, polysiloxane-based coatings, carbamate and/or urea-based coatings, aminoplast-based coatings, film-forming resin compositions comprising a latex emulsion that includes cross-linked polymeric microparticles dispersed in an aqueous continuous phase, and powder clear coatings, all as more fully described in U.S. patent application Ser. No. ______ of C. Knox et al, which has been filed on the same date as the present application and is entitled “Photochromic Optical Article”.

An acrylic-based tie layer, such as the film described in WO 03/058300 A1, can be prepared using acrylic or methacrylic monomers or a mixture of acrylic and/or methacrylic monomers (hereinafter referred to collectively as (meth)acrylic monomers). The mixture of (meth)acrylic monomers can include mono-, di-, tri-, tetra-, and penta- acrylic functional monomers. Additional co-polymerizable monomers, such as epoxy monomers, e.g., monomers containing an epoxy functionality, monomers containing both acrylic and epoxy functionalities, etc., can also be present in the formulation used to prepare the acrylate-based film, as described subsequently herein. The monomers used to prepare the acrylate-based film are typically comprised of a plurality, e.g., a major amount, e.g., more than 50 weight percent, of acrylic-functional monomers; hence the designation “acrylate-based film”. The formulations used to prepare the acrylate-based film can also contain components having at least one isocyanate functionality, e.g., organic monoisocyanates and organic diisocyanates, thereby to incorporate polyurethane groups into the film.

As used herein, the terms “acrylic” and “acrylate” are used interchangeably (unless to do so would alter the intended meaning) and include derivatives of acrylic acids, as well as substituted acrylic acids such as methacrylic acid, ethacrylic acid, etc., unless clearly indicated otherwise. The terms “(meth)acrylic” or “(meth)acrylate” are intended to cover both the acrylic/acrylate and methacrylic/methacrylate forms of the indicated material, e.g., monomer. Since, the second transparent polymeric layer is interposed between the photochromic coating and the abrasion-resistant coating, it serves to tie together these coatings and serves as a barrier to protect the photochromic coating.

Radiation-curable and thermally-curable acrylic-based polymeric systems are well known in the polymeric art and any such system that meets the requirements described elsewhere herein for the photochromic article of the present invention can be used to produce the acrylate-based tie layer film. A contemplated embodiment of a radiation-curable composition for an acrylate-based tie layer film comprises a combination or miscible blend of one or more free-radical initiated acrylate monomers and/or acrylate oligomers, and one or more cationic initiated epoxy monomers. When this blend of monomers is cured, a polymerizate comprising an interpenetrating network of polymer components is produced.

Non-limiting examples of acrylic monomers include polyfunctional acrylates, e.g., di-, tri-, tetra-, and penta- functional acrylates, and monofunctional acrylates, e.g., a monomer containing a single acrylic functionality, hydroxy-substituted monoacrylates and alkoxysilyl alkylacrylates, such as trialkoxysilylpropylmethacrylate. Other reactive monomers/diluents, such as monomers containing an ethylenic functional group (other than the acrylic-functional materials) can also be present.

Many acrylates can be represented by the following general formula II,
R—(OC(O)C(R′)═CH₂)ₙ II
wherein R is an aliphatic or aromatic group containing from 2 to 20 carbon atoms and optionally from 1 to 20 alkyleneoxy linkages; R′ is hydrogen or an alkyl group containing from 1 to 4 carbon atoms, and n is an integer of 1 to 5. When n is greater than 1, R is a linking group that links the acrylic functional groups together. Typically, R′ is hydrogen or methyl, and n is an integer of from 1 to 3. More specifically, diacrylates (when n is 2) can be represented by general formula III, 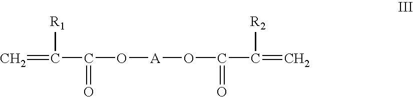
wherein R₁ and R₂ can be the same or different and are each chosen from hydrogen or alkyl groups containing from 1 to 4 carbon atoms, desirably hydrogen or methyl, and A is a hydrocarbyl linking group of, for example, from 1 to 20 carbon atoms, e.g., an alkylene group, one or more oxyalkylene group(s) [or mixture of different oxyalkylene groups]; or a group of the following general formula IV, 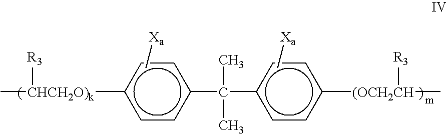
wherein each R₃ is a hydrogen atom or an alkyl group of from 1 to 4 carbon atoms, e.g., methyl; X is a halogen atom, e.g., chlorine; a is an integer of from 0 to 4, e.g., 0 to 1, representing the number of halogen atoms substituted on the benzene ring; and k and m are numbers of from 0 to 20, e.g., 1 to 15, or 2 to 10. The values of k and m are average numbers and when calculated can be a whole number or a fractional number.

Acrylates having an epoxy group can be represented by the following general formula V, 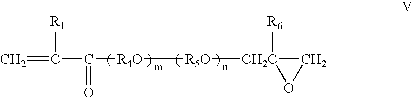
wherein R₁ and R₆ can be the same or different and are each chosen from hydrogen or an alkyl group of from 1 to 4 carbon atoms, e.g., methyl; R₄ and R₅ are alkylene groups containing from 2 to 3 carbon atoms, e.g., ethyleneoxy and propyleneoxy, and m and n are numbers of from 0 to 20, e.g., 0 or 1 to 15 or 2 to 10. When one of m and n is 0 and the other is 1, the remaining R group can be an aromatic group of the following formula VI, 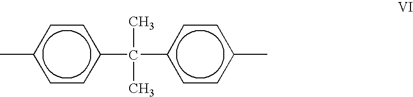
e.g., a group derived from the 2,2′-diphenylenepropane radical, which phenyl groups can be substituted with C₁ to C₄ alkyl groups or halogens, e.g., methyl and/or chlorine.

The amount, number and type of functional acrylates comprising the curable acrylic-based tie layer formulation will vary and will depend on the physical properties of the tie layer that are most desired since, for example, varying the crosslink density of the tie layer, e.g., by varying the amount of tri-functional acrylates or other cross-linking monomers used in the acrylate-based tie layer formulation, will alter the final properties of the tie layer. It is generally accepted that the cross-link density of the cured film is a function of the amount of multifunctional acrylates used. High amounts of multifunctional acrylates lead to high hardness, tensile strength and chemical resistance, but with poorer adhesion to the substrate. In contrast, reducing the amount of multifunctional acrylates and increasing the amount of monofunctional acrylates lead to a lower cross-link density of the cured tie layer with consequent lower hardness, chemical resistance and tensile strength, and a slower cure speed. Therefore, one skilled in the art can vary the amounts of mono- and multi-functional acrylate monomers used depending on whether it is desirable to optimize adhesion to the polymeric coating, hardness (scratch resistance), chemical resistance, e.g., resistance to aqueous alkali metal hydroxide treatment, or other properties; or whether it is desirable to compromise one or more of these properties to obtain an average benefit for all of those physical properties. One skilled in the art can readily select the combination of monomeric materials to be used for the acrylate-based tie layer based on the art-recognized benefits that certain functional groups provide to a radiation-cured acrylate tie layer.

In a further contemplated embodiment, the tie layer is prepared from a composition comprising a mixture of free-radical initiated acrylate monomer(s) and cationic initiated epoxy monomer(s). The curable composition can comprise from 10 to 85 percent by weight of at least one epoxy monomer(s) and from 90 to 15 percent by weight of at least one acrylate monomer(s), more typically, from 30 to 70 weight percent epoxy monomer(s) and from 70 to 30 weight percent acrylate monomer(s), and desirably from 35 to 50 weight percent epoxy monomer(s) and from 65 to 50 weight percent acrylate monomers. Monomers containing both epoxy and acrylic functionality are categorized herein as acrylate monomers. The range of acrylate monomers and epoxy monomers in the curable composition described heretofore can vary between any combination of the stated values, inclusive of the stated values.

Epoxy monomers used in the tie layer film formulation are those monomers that are initiated by cationic initiators. The preferred epoxy monomers are epoxy condensation polymers, such as polyglycidyl ethers of alcohols and phenols, and certain polyepoxy monomers and oligomers. The epoxy monomers improve adhesion of the cured tie layer film to the photochromic coating and enhance other properties of the cured tie layer film, such as improving the adhesion of an abrasion-resistant coating, e.g., a siloxane coating, to a cured acrylate-based tie layer film. Cured acrylate-based tie layer films prepared with epoxy monomers also appear to improve the abrasion resistance of the abrasion-resistant coating (hard coat), when used, that is applied to the photochromic coating and results also in less crazing of the antireflective coating (when used over the hard coat).

Epoxy monomers, e.g., monomers having at least one epoxy group in the molecule can be represented by the following general formula VII, 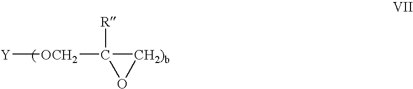
wherein Y is a residue of a b-valent alcoholic hydroxyl compound, a residue of a b-valent phenolic hydroxyl group-containing compound, or a residue of a b-valent carboxylic acid, R″ is a hydrogen atom or a methyl group, and b is an integer of from 1 to 4, typically 1 to 2. These materials include alcoholic hydroxyl group-containing compounds of monohydric dihydric or trihydric alcohols, reaction products between phenolic hydroxyl compounds, such as phenol and hydroquinone, and epichlorohydrin, and reaction products between carboxylic acids, such as benzoic acid and terephthalic acid, and epichlorohydrin.

The epoxy monomer represented by formula VII can also contain (as part of Y) a radical polymerizable group (other than acrylic) such as a vinyl group or an allyl group. Monomers containing an acrylic polymerizable group and an epoxy group are categorized herein with the acrylate monomer(s) previously described.

Non-limiting examples of epoxy monomer compounds having at least one epoxy group in the molecule and not having a polymerizable group include those of formula XIV wherein b is 1 or 2. When b is 1, Y can be an alkyl group having from 2 to 20 carbon atoms, which can be substituted by a hydroxyl group, a cycloalkyl group having from 6 to 7 carbon atoms, which can be substituted by a hydroxyl group, a phenyl group, which can be substituted by a hydroxyl group, a benzoyl group, which can be substituted by a carboxyl group, or a hydroxyalkyleneoxy group. When b is 2, Y can be an alkylene group containing from 2 to 20 carbon atoms, which can be substituted by a hydroxyl group, a cycloalkylene group, which can be substituted by a hydroxyl group, a phenylene group, which can be substituted by a hydroxyl group, a phthaloyl group, an isophthaloyl group, a terephthaloyl group, a 2,2′-bisphenylene propyl group, and an alkyleneoxy group. The alkyleneoxy group can have from 1 to 20 alkyleneoxy groups, and the alkylene moiety can have from 2 to 4 carbon atoms.

Non-limiting examples of epoxy compounds include ethylene glycol glycidyl ether, propylene glycol glycidyl ether, 1,4-butanediol diglycidyl ether, glycerol polyglycidyl ether, diglycerol polyglycidyl ether, sorbitol polyglycidyl ether, butyl glycidyl ether, phenyl glycidyl ether, polyethylene glycol diglycidyl ether, polypropylene glycol diglycidyl ether, neopentyl glycol diglycidyl ether, 1,6-hexanediol diglycidyl ether, propylene carbonate, bisphenol A or hydrogenated bisphenol A propylene oxide adduct, diglycidyl ester of terephthalic acid, spiroglycol diglycidyl ether, hydroquinone diglycidyl ether and 3,4-epoxycyclohexane carboxylate.

Epoxy condensation polymers that can be used are polyepoxides having a 1,2-epoxy equivalency greater than 1, e.g., up to 3. Non-limiting examples of such epoxies are polyglycidyl ethers of polyhydric phenols and aliphatic (cyclic and alicyclic) alcohols. These polyepoxides can be produced by etherification of the polyhydric phenol or aliphatic alcohol with an epihalohydrin, such as epichlorohydrin, in the presence of an alkali, such as sodium hydroxide. Non-limiting examples of suitable polyphenols are 2,2-bis(4-hydroxyphenyl)propane, e.g., bisphenol A, 1,1-bis(4-hydroxyphenyl)ethane, and 2-methyl-1,1-bis(4-hydroxyphenyl)propane. Non-limiting examples of aliphatic alcohols include ethylene glycol, diethylene glycol, 1,2-propylene glycol, 1,4-butylene glycol, 1,2-cyclohexanediol, 1,4-cyclohexanediol, 1,2-bis(hydroxymethyl)cyclohexane and hydrogenated bisphenol A. These epoxies are available from Resolution Performance Products under the EPON trade name.

Non-limiting examples of polyepoxide monomers and oligomers are described in U.S. Pat. No. 4,102,942 (column 3, lines 1-16). Specific examples of such polyepoxides are 3,4-epoxycyclohexylmethyl, 3,4-epoxycyclohexanecarboxylate and bis(3,4-epoxycyclohexylmethyl)adipate. Aliphatic polyepoxides are available from the Dow Corporation under the CYRACURE trade name.

Monomeric materials that can be used to prepare the further curable transparent polymeric film/tie layer formulation are commercially available; and, if not commercially available, can be prepared by procedures well known to those skilled in the art. Non-limiting examples of commercial acrylate materials can be found in U.S. Pat. No. 5,910,375, particularly in the disclosure found in column 8, lines 20-55, and in column 10, lines 5-36. Commercially available acrylate materials are available from various manufacturers and include those sold under the tradenames, SARTOMER, EBECRYL, and PHOTOMER.

The transparent further polymeric film/layer formulation can include other additives known to those skilled in the art. These additives can include, but are not limited to, flow and leveling additives, wetting agents, antifoaming agents, UV absorbers, rheology modifiers, surfactants, e.g., fluorosurfactants, stabilizers and antioxidants. Care should be observed, however, in the case of UV absorbers that sufficient UV radiation of the appropriate wavelength is permitted to pass through the further polymeric film/layer to activate the photochromic materials(s) within the photochromic polymeric coating. Such materials are well known to those skilled in the art, and examples of some commercial surfactants and antioxidants/stabilizers can be found in column 10, lines 43-54 of the aforementioned '375 patent. Other non-limiting examples of such additives include silicones, modified silicones, silicone acrylates, hydrocarbons, and other fluorine-containing compounds.

As disclosed in copending U.S. patent application Ser. No. ______ filed on same date as the present application by W. Blackburn et al and entitled “Photochromic Optical Article”, it is contemplated further that an adhesion-enhancing amount of at least one adhesion promoting material (adhesion promoter) can be incorporated into the curable composition comprising the transparent polymeric tie layer. By adhesion-enhancing amount is meant that the compatibility of the second transparent polymeric layer to a superimposed organo silane-containing abrasion-resistant coating (as described herein) is enhanced. Typically, from 0.1 to 20 weight percent of at least one adhesion promoter(s) is incorporated into the coating composition comprising the second transparent polymeric layer prior to applying it onto the photochromic coating. More particularly, from 0.5 to 16, e.g., 0.5 to 10, weight percent, more particularly 0.5 to 8, e.g., 5, weight percent, of at least one adhesion promoter is incorporated into the tie layer. The amount of adhesion promoter incorporated into the second transparent polymeric layer can range between any combination of the aforestated values, inclusive of the recited values.

Among the adhesion promoter materials that can be incorporated into the transparent polymeric tie layer to enhance its compatibility with an abrasion-resistant coating, e.g., an abrasion-resistant coating comprising organo-silane material, include, but are not limited to, adhesion promoting organo-silane materials, such as aminoorganosilanes and silane coupling agents, organic titanate coupling agents and organic zirconate coupling agents.

Aminoorganosilanes that can be used are primary, secondary and tertiary aminoorganosilanes, particularly aminoorganosilanes represented by the following general formula VIII: 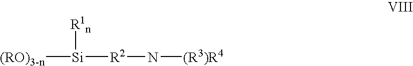
wherein n is an integer of from 0 to 2, usually 0 or 1; each R is independently chosen from C₁-C₈ alkyl, usually C₁-C₄ alkyl, such as methyl, ethyl, propyl and butyl, a C₁-C₄ alkoxy C₁-C₈ alkyl, typically C₁-C₃ alkoxy C₁-C₃ alkyl, such as methoxymethyl, methoxyethyl, ethoxymethyl, etc., or C₆-C₁₀aryl, e.g., C₆-C₈ aryl; R¹ is hydrogen or a C₁-C₈ alkyl, usually C₁-C₃ alkyl, or C₆-C₁₀ aryl, e.g., C₆-C₈ aryl; R² is a divalent C₁-C₁₀ alkylene, C₂-C₁₀ alkenylene or phenylene, usually a C₂-C₅ alkylene, such as ethylene, trimethylene, etc., or C₂-C₅ alkenylene, such as vinylene, 1-propenylene, butenylene, 2-pentenylene, etc.; each R³ and R⁴ are independently chosen from hydrogen, C₁-C₈ alkyl, usually C₁-C₃ alkyl, C₁-C₈ hydroxyalkyl, usually C₂-C₃ hydroxyalkyl, C₁-C₈ aminoalkyl, usually C₂-C₃ aminoalkyl, C₄-C₇ cycloalkyl, e.g., C₅-C₆ cycloalkyl, C₆-C₁₀ aryl, e.g., C₆-C₈ aryl, (meth)acrylyloxy C₁-C₄ alkyl (the alkyl group being optionally substituted with a functional group such as hydroxy), e.g., (meth)acrylyloxy-2-hydroxypropyl, or R³ and R⁴ combine to form a cycloalkyl group of from 4 to 7 carbon atoms, e.g., 5 to 6 carbon atoms, or a C₄-C₇ heterocyclic group wherein the hetero atom(s) are oxygen and/or nitrogen, e.g., morpholino and piperazino, or are a group represented by the general formula IX 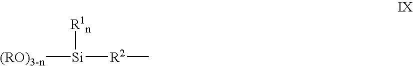
wherein R, R¹, R² and n are as defined with respect to general formula VIII. Also included in the compounds of formula IX are the partial and total hydrolysates of compounds represented by that formula.

Non-limiting examples of aminosilanes that can be used include aminopropyl trimethoxysilane, aminopropyl triethoxysilane, aminoethyl trimethoxysilane, aminoethyl triethoxysilane, methylaminopropyl trimethoxysilane, aminobutylmethyl dimethoxysilane, aminopropyldimethyl methoxysilane, aminopropylmethyl dimethoxysilane, aminopropyldimethyl ethoxysilane, aminobutylmethyl dimethoxysilane, bis-(gamma-trimethoxysilylpropyl) amine, N-(3-methacryloxy-2-hydroxypropyl)-3-aminopropyl triethoxysilane, N-(3acryloxy-2-hydroxypropyl)-3-aminopropyl triethoxysilane, (N,N-dimethylaminopropyl) trimethoxysilane, (N,N-diethyl-3-aminopropyl) trimethoxysilane, diethylaminomethyl triethoxysilane, bis(2-hydroxyethyl)-3-aminopropyl triethoxysilane, γ-aminopropyl trimethoxysilane, N-(2′-aminoethyl)-3-aminopropyl trimethoxysilane, N-(2′-aminoethyl)-3-aminopropyl triethoxysilane, N-butyl-3-aminopropyl triethoxysilane, N-octyl-3-aminopropyl trimethoxysilane, N-cyclohexyl-3-aminopropyl triethoxysilane, N-(3′-triethoxysilylpropyl)-piperazine, bis-(3-triethoxysilylpropyl)amine, tris-(3-trimethoxysilylpropyl)amine, N,N-dimethyl-3-aminopropyl triethoxysilane, N-methyl-N-butyl-3-aminopropyl triethoxysilane, N-(3′-aminopropyl)-3-aminopropyl triethoxysilane, N-(3′-triethoxysilylpropyl) morpholine, N-phenyl-gamma-aminopropyl trimethoxysilane, and N-phenyl-gamma-amino-2-methylpropyl trimethoxysilane.

Silane coupling agents can be represented by the following general formula X:
(R⁵)ₐ(R⁶)_{b}Si[(OR)₃]_{c} X
wherein each R⁵ is an organofunctional group independently chosen from epoxy, glycidoxy, amino, vinyl, styryl, (meth)acryloxy, mercapto, haloalkyl, e.g., chloroalkyl, ureido, or a hydrocarbon radical having not more than 10 carbon atoms substituted with said organofunctional group; each R⁶ is a hydrocarbon radical of not more than 20 carbon atoms, that is independently chosen from aliphatic radicals, aromatic radicals or mixtures of such hydrocarbon radicals, e.g., C₁-C₂₀ alkyl, more particularly, C₁-C₁₀ alkyl, e.g., C₁-C₆ alkyl, or phenyl; each R is independently chosen from C₁-C₈ alkyl, usually C₁-C₄ alkyl, such as methyl, ethyl, propyl and butyl, a C₁-C₄ alkoxy C₁-C₈ alkyl, typically C₁-C₃ alkoxy C₁-C₃ alkyl, such as methoxymethyl, methoxyethyl, ethoxymethyl, etc., C₆-C₁₀ aryl, e.g., C₆-C₈ aryl or acetoxy;, a is the integer 1 or 2, usually 1, b is the integer 0, 1 or 2, e.g., 0, and c is the integer 1, 2, or 3, e.g., 2 or 3, provided that the sum of a+b+c equals 4.

Non-limiting examples of silane coupling agents include: vinyl triacetoxysilane, vinyl trimethoxysilane, vinyl tri(2-methoxyethoxy)silane, vinyl triphenoxysilane, vinyl triisopropoxysilane, vinyl tri-t-butoxysilane, divinyl diethoxysilane, gamma glycidoxypropyl trimethoxysilane, beta-(3,4-epoxycyclohexyl)ethyl trimethoxysilane, allyl triethoxysilane, allyl trimethoxysilane, (3-acryloxypropyl) dimethylmethoxysilane, (3-acryloxypropyl) methyldimethoxysilane, (3-acryloxypropyl) trimethoxysilane, (3-methacryloxypropyl) trimethoxysilane, (methacryloxymethyl) dimethyl ethoxysilane, methacryloxymethyl triethoxysilane, methacryloxymethyl trimethoxysilane, methacryloxypropyl dimethyl ethoxysilane, methacryloxypropyl trimethoxysilane, styrylethyl trimethoxysilane, mercaptomethyl methyldiethoxysilane, 3-mercaptopropyl methyldimethoxysilane, 3-mercaptopropyl triethoxysilane, 3-mercaptopropyl trimethoxysilane, 3,4-epoxy cyclohexylethyl trimethoxysilane, dimethyl diethoxysilane, chloropropyl triethoxysilane, 3-(trimethoxysilyl)propyl methacrylate, ureidopropyl triethoxysilane, mixtures of such silane materials, and at least partial hydrolysates of such silanes.

Non-limiting examples of organic titanate coupling agents include: tetra (2,2-diallyloxymethyl)butyl titanate, di(ditridecyl)phosphito titanate (commercially available as KR 55 from Kenrich Petrochemicals, Inc.); neopentyl(diallyl)oxy trineodecanoyl titanate; neopentyl (diallyl)oxy tri(dodecyl)benzene-sulfonyl-titanate; neopentyl (diallyl)oxy tri(dioctyl)phosphato titanate; neopentyl (diallyl)oxy tri(dioctyl) pyro-phosphato titanate; neopentyl (diallyl)oxy tri (N-ethylenediamino)ethyl titanate; neopentyl (diallyl)oxy tri(m-amino) phenyl titanate; neopentyl (diallyl)oxy trihydroxy caproyl titanate; isopropyl dimethyacrylisostearoyl titanate; tetraisopropyl (dioctyl) phosphito titanate; mixtures of such titanates, and at least partial hydrolysates thereof.

Non-limiting examples of organic zirconate coupling agents include tetra (2,2-diallyloxymethyl)butyl di(ditridecyl)phosphito zirconate (commercially available as KZ 55 from Kenrich Petrochemicals); neopentyl(diallyloxy) trineodecanoyl zirconate; neopentyl(diallyl)oxy tri(dodecyl)benzene sulfonyl zirconate; neopentyl(diallyloxy) tri(dioctyl)phosphato zirconate; neopentyl (diallyloxy) tri(dioctyl)pyro-phosphato zirconate; neopentyl(diallyloxy) tri(N-ethylenediamino)ethyl zirconate; neopentyl (diallyloxy), tri(m-amino)phenyl zirconate; neopentyl (diallyloxy) trimethacryl zirconate; neopentyl (diallyloxy) triacryl zirconate; dineopentyl(diallyloxy) di(p-amino) benzoyl zirconate; dineopentyl (allyl)oxy di(3-mercapto) propionic zirconate; mixtures of such zirconates, and at least partial hydrolysates thereof.

As used in this description and claims, the term “at least partial hydrolysates” is intended to mean and include compounds that are hydrolyzed partially or hydrolyzed completely.

The curable transparent polymeric tie layer film formulation is prepared by mixing the components of the formulation at room temperature, although mild heating can be used to facilitate mixing and blending. The formulation can then be applied to the photochromic coating by the same procedures that have been described for applying the photochromic coating to the plastic substrate, e.g., spin coating and dip coating.

The curable transparent polymeric tie layer film is applied in a manner to obtain a substantially homogeneous cured film, which can range in thickness from 2 to 20 microns, e.g., 2 to 15 microns, more typically from 8 to 12 microns. The thickness of the tie layer can range between any combinations of these values, inclusive of the recited values. It is contemplated that more than one polymeric film can be used as the tie layer, and that such multiple films can be of different compositions and hardness values. The term “film” is generally considered by those skilled in the coating art to be a layer with a thickness of not more than 20 mils (500 microns); however, as used in this disclosure and claims, the term film when used in relation to the further transparent polymeric film is defined as having a thickness, as herein described.

The applied film is then cured by any appropriate method, e.g., thermally and/or exposure to UV radiation. Any appropriate type of UV lamp, e.g., mercury vapor or pulsed xenon, can be used. The absorbance spectra of the photoinitiator(s) should be matched with the spectral output of the UV lamp (bulb), e.g., an H bulb, D bulb, Q bulb or V bulb, for the highest curing efficiency. The cure process is generally more efficient when oxygen, e.g., air, is excluded from the cure process. This can be accomplished by using a nitrogen blanket over the applied film during the cure process.

Following the UV cure, a thermal post cure can be used to cure completely the polymeric tie layer film. Heating in an oven at 212° F. (100° C.) for from 0.5 to 3 hours is usually adequate to thoroughly cure such a tie layer. The previous discussion respecting radiation curing of the photochromic coating is also applicable here in connection with the cure of the second transparent polymeric film.

In a further contemplated embodiment, an abrasion-resistant coating is superposed, e.g., superimposed, on the photochromic polymeric coating or the further transparent polymeric layer/film. In the later embodiment, the post thermal cure of the further polymeric layer/film can be postponed until after application of the abrasion-resistant coating if there is no significant physical handling of the product until after application of the abrasion-resistant coating. If such extensive handling is required, it is suggested that the thermal post cure be performed prior to application of the abrasion-resistant coating.

The scratch resistance of the further transparent polymeric layer/film can be measured by the conventional steel wool scratch test. This test measures the average haze gain of a surface subjected to abrasion by very fine steel wool. In accordance with a preferred embodiment of the present invention, the average haze gain should be less than 20, typically less than 15, more typically less than 10, and still more typically less than 8. An Eberbach Steel Wool Abrasion Tester can be used to determine surface scratch resistance. A Bayer Abrasion Tester can also be used to determine surface abrasion resistance.

Desirably, the further transparent polymeric layer/film should also adhere firmly to the photochromic coating applied to the transparent, e.g., plastic, substrate. Adhesion can be determined by the conventional art recognized crosshatch tape peel adhesion test, and by a boiling water crosshatch tape peel adhesion test, which is a more stringent test. The former is often referred to as the primary (1°) test or dry test; while the later is often referred to as the secondary (2°) or wet test. In the primary test, a cutting tool composed of eleven blades spaced approximately 1 mm apart (tip to tip) and 0.65 mm thick is used to make a first long cut on the sample followed by second and third cuts, which are made at 90 degrees to and across the first cut. The second and third cuts are separated from each other to provide separate crosshatch zones. A piece of Scotch 3M masking tape one inch (2.54 cm) wide and 2 to 2 ½ inches long (5 to 6.3 cm) is applied in the direction of the first cut and pressed down to smooth out any bubbles. The tape is then peeled off the surface with a sharp, rapid, even and continuous movement. The procedure is repeated with a fresh piece of tape. A small piece of tape (1-½ inches, 3.8 cm) is applied to each of the crosshatch zones produced by the second and third cuts in a direction 90 degrees to the direction of the first tape, and these pieces of tape also peeled off the surface with a sharp, rapid, even and continuous movement. If 30 percent or less of the squares of the grid produced by the cutting tool are found to have debonded from the substrate (photochromic coating), e.g., at least 70 percent of the grids remain intact, the coating is deemed to pass the adhesion test. More particularly, it is desirable that no more than 20, particularly no more than 10, squares, still more particularly, no more than 5 squares, e.g., 1 square, out of a 100 squares of the grid de-bond from the substrate. In accordance with an embodiment of the present invention, the further transparent polymeric film should pass the crosshatch tape peel adhesion test to be considered to have adhered to the photochromic coating. Stated differently, if the further transparent polymeric layer/film passes the crosshatch tape peel test, it is referred to herein as being coherently appended (or cohesively appended) or attached to the layer, e.g., the photochromic coating, to which it is appended.

A further more severe adhesion test, e.g., the secondary or wet adhesion test, optionally can be performed to assess adhesion. This further test, e.g., the boiling water cross-hatch adhesion test, involves placing the test sample, e.g., lens, which has been scored with cross hatches, as described above, in boiling deionized water for 30 minutes. After the test sample has cooled to room temperature, the crosshatch tape peel adhesion test, as described above, is performed again. The same pass/fail requirements that were described for the crosshatch adhesion test are used for this boiling water modification of the test.

It is also desirable that the transparent polymeric tie layer/film be resistant to removal by aqueous inorganic caustic solutions, e.g., relatively dilute alkali metal hydroxide solutions, such as solutions of sodium hydroxide or potassium hydroxide. The film is considered to be resistant to removal by such solutions if the thickness of the film is reduced not more than 0.5 micron after exposure to 12.5% aqueous potassium hydroxide at 140° F. (60° C.) for four minutes. Desirably, the film thickness is not reduced more than 0.5 microns after two exposures, more desirably after three exposures, to the aqueous potassium hydroxide solution.

It is further desirable that the transparent polymeric tie layer/film be compatible with organo silane-containing abrasion-resistant coatings used to protect plastic surfaces from abrasions, scratches, etc, and which can be appended to the second transparent polymeric layer. Organo silane abrasion-resistant coatings, often referred to as hard coats or silicone-based hard coatings, are well known in the art, and are commercially available from various manufacturers, such as SDC Coatings, Inc. and PPG Industries, Inc. Reference is made to column 5, lines 1-45 of U.S. Pat. No. 4,756,973, and to column 1, lines 58 through column 2, line 8, and column 3, line 52 through column 5, line 50 of U.S. Pat. No. 5,462,806, which disclosures describe organo silane hard coatings. Reference is also made to U.S. Pat. Nos. 4,731,264, 5,134,191, 5,231,156 and International Patent Publication WO 94/20581 for disclosures of organo silane hard coatings.

While a described desirable physical feature of the further transparent polymeric, layer/film is that it be compatible with organo silane hard coatings, other coatings that provide abrasion and scratch resistance, such as polyfunctional acrylic hard coatings, melamine-based hard coatings, urethane-based hard coatings, alkyd-based coatings, silica sol-based hard coatings or other organic or inorganic/organic hybrid hard coatings can be used as the abrasion-resistant coating.

One skilled in the art can readily determine if the further transparent polymeric layer/film is compatible with organo silane hard coatings by applying an organo silane hard coat to the further transparent polymeric layer/film and determining the compatibility of the second polymeric layer/film to that hard coat by means of the cross-hatch tape peel adhesion test, which is performed on the hard coat. Another method of determining compatibility of the further transparent polymeric layer to the hard coat is the absence of crazing in the hard coat after it has been applied to the second polymeric layer and cured. By crazing is meant the presence of fractures in the hard coat. Such fractures are sometimes readily apparent by observation; however, the fractures can be very fine and observable by magnification under bright light. The bright light can be a high intensity white arc light of a 75 watt Xenon bulb, with the light being projected vertically down through the hard coat.

By use of the term “compatible with an organo silane abrasion resistant coating (hard coat)” is meant that the specified layer, coating or film is capable of having an organo silane hard coat deposited on its surface and that the organo silane hard coat adheres to the film under ordinary handling/wear conditions. Naturally, the organo silane hard coat can be removed by treatment with concentrated aqueous caustic, or severe mechanical abrasion. Further, the term abrasion-resistant organo silane-containing coating (or other such similar meaning terms) is meant that the abrasion-resistant coating is prepared from a composition comprising at least one organo silane.

It is contemplated that, if required, a primer coating is applied to the transparent further polymeric layer before applying the abrasion-resistant coating on top of it. Such primer coatings are known in the art. Selection of an appropriate primer coating will depend on the particular second polymeric layer and abrasion-resistant coating used, e.g., the primer coating must be chemically and physically compatible (non-reactive) with the surfaces that it abuts. The primer coating can be one or several monomolecular layers thick, and can range from 0.1 to 10 microns, e.g., from 0.1 to 2 or 3 microns, in thickness. Such primer coatings are discussed herein in relation to the photochromic coating, and that discussion is applicable here also.

In one embodiment, the hard coat can be prepared from a composition comprising from 35 to 95 weight percent, as calculated solids, of at least one organo silane monomer represented by the following empirical formula XI:
R¹SiW₃ XI

wherein R¹ can be glycidoxy(C₁-C₂₀)alkyl, desirably glycidoxy(C₁-C₁₀)alkyl, and most desirably, glycidoxy (C₁-C₄)alkyl; W can be hydrogen, halogen, hydroxy, C₁-C₅ alkoxy, C₁-C₅ alkoxy(C₁-C₅)alkoxy, C₁-C₄ acyloxy, phenoxy, C₁-C₃ alkylphenoxy, or C₁-C₃ alkoxyphenoxy, said halogen being bromo, chloro or fluoro. Desirably, W is hydrogen, halogen, hydroxy, C₁-C₃ alkoxy, C₁-C₃ alkoxy(C₁-C₃)alkoxy, C₁-C₂ acyloxy, phenoxy, C₁-C₂ alkylphenoxy, or C₁-C₂ alkoxyphenoxy, and the halogen is chloro or fluoro. More desirably, W is hydroxy, C₁-C₃ alkoxy, C₁-C₃ alkoxy(C₁-C₃)alkoxy, C₁-C₂ acyloxy, phenoxy, C₁-C₂ alkylphenoxy, or C₁-C₂ alkoxyphenoxy.

The weight percent, as calculated solids, of the silane monomers represented by empirical formula XI in the hard coat composition is desirably from 40 to 90, more desirably from 45 to 85, and most desirably from 50 to 70 weight percent calculated solids. The weight percent calculated solids are determined as the percent of the silanol that theoretically forms during the hydrolysis of the orthosilicate.

Non-limiting examples of silane monomers represented by general formula XI include glycidoxymethyltriethoxysilane, glycidoxymethyltrimethoxysilane, alpha-glycidoxyethyltrimethoxysilane, alpha-glycidoxyethyltriethoxysilane, alpha-glycidoxypropyltrimethoxysilane, alpha-glycidoxypropyltriethoxysilane, alpha-glycidoxypropyltrimethoxysilane, alpha-glycidoxypropyltriethoxysilane, beta-glycidoxyethyltrimethoxysilane, beta-glycidoxyethyltriethoxysilane, beta-glycidoxypropyltrimethoxysilane, beta-glycidoxypropyltriethoxysilane, beta-glycidoxybutyltrimethoxysilane, beta-glycidoxybutyltriethoxysilane, gamma-glycidoxypropyltrimethoxysilane, gamma-glycidoxypropyltriethoxysilane, gamma-glycidoxypropyltripropoxysilane, gamma-glycidoxypropyltributoxysilane, gamma-glycidoxypropyltrimethoxysilane, gamma-glycidoxypropyltriphenoxysilane, gamma-glycidoxybutyltrimethoxysilane, gamma-glycidoxybutyltriethoxysilane, delta-glycidoxybutyltrimethoxysilane, delta-glycidoxybutyltriethoxysilane, hydrolyzates of such silane monomers, and mixtures of such silane monomers and hydrolyzates thereof.

The hard coat composition of the foregoing described embodiments can further include from 5 to 65 weight percent, as calculated solids, of: (a) silane monomers represented by empirical formula XII, (b) metal alkoxides represented by empirical formula XIII, or (c) a mixture thereof in a weight ratio of (a):(b) of from 1:100 to 100:1. Desirably, the hard coat composition includes from 10 to 60 weight percent calculated solids, more desirably from 15 to 55, and most desirably from 30 to 50 weight percent calculated solids of the aforementioned materials (a), (b) or (c).

The hard coat composition can include at least one silane monomer represented by the following empirical formula XII:
R²_{b}(R³)_{c}SiZ_{4-(b+c)} XII
wherein R² can be C₁-C₂₀ alkyl, C₁-C₂₀ haloalkyl, C₂-C₂₀ alkenyl, C₂-C₂₀ haloalkenyl, phenyl, phenyl(C₁-C₂₀)alkyl, C₁-C₂₀ alkylphenyl, phenyl(C₂-C₂₀)alkenyl, C₂-C₂₀ alkenylphenyl, morpholino, amino(C₁-C₂₀)alkyl, amino(C₂-C₂₀)alkenyl, mercapto(C₁-C₂₀)alkyl, mercapto(C₂-C₂₀)alkenyl, cyano(C₁-C₂₀)alkyl, cyano(C₂-C₂₀)alkenyl, acryloxy, methacryloxy, or halogen. The halo or halogen can be bromo, chloro, or fluoro. Desirably, R² is a C₁-C₁₀ alkyl, C₁-C₁₀ haloalkyl, C₂-C₁₀ alkenyl, phenyl, phenyl(C₁-C₁₀)alkyl, C₁-C₁₀ alkylphenyl, morpholino, amino(C₁-C₁₀) alkyl, amino(C₂-C₁₀) alkenyl, mercapto(C₁-C₁₀)alkyl, mercapto(C₂-C₁₀) alkenyl, cyano(C₁-C₁₀) alkyl, cyano(C₂-C₁₀)alkenyl, or halogen and the halo or halogen is chloro or fluoro.

In formula XII, R³ can be C₁-C₂₀ alkylene, C₂-C₂₀ alkenylene, phenylene, C₁-C₂₀ alkylenephenylene, amino(C₁-C₂₀)alkylene, or amino(C₂-C₂₀)alkenylene; Z can be hydrogen, halogen, hydroxy, C₁-C₅ alkoxy, C₁-C₅ alkoxy(C₁-C₅)alkoxy, C₁-C₄ acyloxy, phenoxy, C₁-C₃ alkylphenoxy, or C₁-C₃ alkoxyphenoxy, said halo or halogen being bromo, chloro or fluoro; b and c are each an integer of from 0 to 2; and the sum of b and c is an integer of from 0 to 3. Desirably, R³ is C₁-C₁₀ alkylene, C₂-C₁₀ alkenylene, phenylene, C₁-C₁₀ alkylenephenylene, amino(C₁-C₁₀)alkylene, amino(C₂-C₁₀)alkenylene, Z is hydrogen, halogen, hydroxy, C₁-C₃ alkoxy, C₁-C₃ alkoxy(C₁-C₃)alkoxy, C₁-C₂ acyloxy, phenoxy, C₁-C₂ alkylphenoxy, or C₁-C₂ alkoxyphenoxy, and the halo or halogen is chloro or fluoro.

Non-limiting examples of silane monomers represented by general formula XII include methyltrimethoxysilane, methyl-triethoxysilane, methyltrimethoxyethoxysilane, methyltri-acetoxysilane, methyltripropoxysilane, methyltributoxysilane, ethyltrimethoxysilane, ethyltriethoxysilane, and gamma-methacryloxypropyl trimethoxysilane, gamma-aminopropyltrimethoxysilane, gamma-aminopropyltriethoxysilane, gamma-mercaptopropyltrimethoxysilane, chloromethyltrimethoxysilane, chloromethyltriethoxysilane, dimethyldiethoxysilane, gamma-chloropropylmethyldimethoxysilane, gamma-chloropropyl-methyldiethoxysilane, tetramethylorthosilicate, tetraethylorthosilicate, hydrolyzates of such silane monomers, and mixtures of such silane monomers and hydrolyzates thereof.

The hard coat composition can include at least one compound represented by empirical formula XIII:
M(T)_{q} XIII
wherein M is a metal chosen from aluminum, antimony, tantalum, titanium or zirconium; T is C₁-C₁₀ alkoxy and q is an integer equivalent to the valence of M. Desirably, M is chosen from aluminum, titanium or zirconium and T is C₁-C₅ alkoxy, e.g., propoxy.

The hard coat composition can also include from 0 to 20 weight percent, based on the total weight of the composition, of a metal oxide chosen from silicon dioxide (silica), aluminum oxide (alumina), antimony oxide, tin oxide, titanium oxide, zirconium oxide or mixtures of such metal oxides. The metal oxide can be in the form of a sol. As used in the present specification, the term sol means and includes a colloidal dispersion of finely divided solid inorganic metal oxide particles in an aqueous or an organic liquid. The average size of such particles can range from 1 to 200 nanometers, typically from 2 to 100 nanometers, and more typically, from 5 to 50 nanometers.

Such metal oxide sols can be prepared by hydrolyzing a metal salt precursor for a time sufficient to form the desired particle size or such sols can be purchased commercially. Examples of commercially available metal oxide sols that can be used in the hard coat composition include NALCO® colloidal sols (available from NALCO Chemical Co.), REMASOL® colloidal sols (available from Remet Corp.) and LUDOX® colloidal sols (available from E.I. du Pont de Nemours Co., Inc.). Stable acidic and alkaline metal oxide sols are commercially available as aqueous dispersions. Desirably, the metal oxide is silica or alumina supplied in the form of an acid stabilized colloidal silica, acid stabilized colloidal alumina, e.g., NALCO® 8676, or an acid stabilized alumina coated silica sol, e.g., NALCO® 1056. Metal oxide sols can also be obtained as dispersions in organic liquids, e.g., ethanol, isopropyl alcohol, ethylene glycol and 2 propoxyethanol.

The hard coat composition also contains a catalytic amount of a water-soluble acid catalyst. A catalytic amount is that amount which is sufficient to cause polycondensation of the silane monomer(s). Typically, the catalytic amount of acid catalyst will range from 0.01 to 10 weight percent, based on the total weight of the hard coat composition. The water-soluble acid catalyst can be an organic carboxylic acid or an inorganic acid. Non-limiting examples of suitable catalysts include acetic acid, formic acid, glutaric acid, maleic acid, nitric acid, sulfuric acid and hydrochloric acid.

Organic solvents present in the hard coat composition can be added or formed in situ by the hydrolysis of the silane monomer(s). Useful organic solvents are those that will dissolve or disperse the solid components of the coating composition. The minimum amount of solvent present in the coating composition is a solvating amount, e.g., an amount that is sufficient to solubilize or disperse the solid components in the coating composition. For example, the amount of solvent present can range from 20 to 90 weight percent based on the total weight of the coating composition and depends, in part, on the amount of silane monomer present in the coating composition. Examples of solvents include, but are not limited to: benzene, toluene, methyl ethyl ketone, methyl isobutyl ketone, acetone, ethanol, tetrahydrofurfuryl alcohol, propyl alcohol, propylene carbonate, N-methylpyrrolidinone, N-vinylpyrrolidinone, N-acetylpyrrolidinone, N-hydroxymethylpyrrolidinone, N-butyl-pyrrolidinone, N-ethylpyrrolidinone, N-(N-octyl)-pyrrolidinone, N-(n-dodecyl)pyrrolidinone, 2-methoxyethyl ether, xylene, cyclohexane, 3-methylcyclohexanone, ethyl acetate, butyl acetate, tetrahydrofuran, methanol, amyl propionate, methyl propionate, diethylene glycol monobutyl ether, dimethyl sulfoxide, dimethyl formamide, ethylene glycol, mono- and dialkyl ethers of ethylene glycol and their derivatives, which are sold under the trade name CELLOSOLVE industrial solvents, propylene glycol methyl ether and propylene glycol methyl ether acetate, which are sold under the trade name DOWANOL® PM and PMA solvents, respectively, and mixtures of such solvents.

A leveling amount of nonionic surfactant(s) can be present as a component in the hard coat composition. A leveling amount is that amount which is sufficient to allow the coating to spread evenly or to level the hard coat composition on the surface of the further transparent polymeric film/layer to which it is applied. Desirably, the nonionic surfactant is a liquid at the conditions of use and is used in amounts from about 0.05 to about 1.0 weight percent based on the amount of the silane monomer(s). Non-limiting examples of nonionic surfactants are described in the Kirk Othmer Encyclopedia of Chemical Technology, 3rd Edition, Volume 22, pages 360 to 377. Other examples of nonionic surfactants include the surfactants described in U.S. Pat. No. 5,580,819, column 7, line 32 to column 8, line 46.

Non-limiting examples of nonionic surfactants that can be used in the hard coat composition include ethoxylated alkyl phenols, such as the IGEPAL® DM surfactants or octyl-phenoxypolyethoxyethanol, which is sold as TRITON® X-100, an acetylenic diol such as 2,4,7,9-tetramethyl-5-decyne-4,7-diol, which is sold as SURFYNOL® 104, ethoxylated acetylenic diols, such as the SURFYNOL® 400 surfactant series, fluoro-surfactants, such as the FLUORAD® fluorochemical surfactant series, and capped nonionics, such as the benzyl capped octyl phenol ethoxylates, which is sold as TRITON® CF87, the propylene oxide capped alkyl ethoxylates, which are available as the PLURAFAC® RA series of surfactants, octylphenoxyhexadecylethoxy benzyl ether, polyether modified dimethylpolysiloxane copolymer in solvent, which is sold as BYK®-306 additive by Byk Chemie and mixtures of such recited surfactants.

Water is also present in the hard coat composition in an amount sufficient to form hydrolysates of the silane monomer(s). The water present in the optional metal oxide sol can supply the amount of water necessary. If not, additional water can be added to the coating composition to provide the required additional amount necessary to hydrolyze the silane monomer(s).

The abrasion-resistant coating (hard coat) can be superposed on, e.g., applied to, the transparent polymer tie layer/film using the same application techniques described with respect to the photochromic coating, e.g., spin coating. The abrasion resistant film can be applied at a thickness of from 0.5 to 10 microns. Prior to applying the hard coating, e.g., the organo silane hard coat, to the second transparent polymeric layer/film, the film can be treated to enhance its receptivity of and adhesion of the hard coat. Such treatments, e.g., plasma treatments, as are described above with respect to pretreatment of the photochromic coating can be used.

In a further embodiment of the present invention, additional coatings, such as antireflective coatings, can be applied to the hard coat layer. Examples of antireflective coatings are described in U.S. Pat. No. 6,175,450 and International Patent Publication WO 00/331 11.

The present invention is more particularly described in the following example, which is intended as illustrative only, since numerous modifications and variations therein will be apparent to those skilled in the art. In the examples, percentages are reported as weight percent, unless otherwise specified. Materials, such as monomers, catalysts, initiators, etc.), which are identified in one example by a lower case letter in parenthesis, are similarly identified in subsequent examples.

In the following example, residual bleach colors (a*) and (b*) values are obtained by use of a Hunter Spectrophotometer and are expressed in Table 3 based on the CIELAB system. See column 7, lines 14-39 of U.S. Pat. No. 5,753,146 and pages 47-52 of Principles of Color Technology, by F. W. Billmeyer, Jr., and Max Saltzman, Second Edition, John Wiley and Sons, New York (1981) for a description of the CIELAB system. In this system, a* and b* describe color, a positive a* being red, a negative a* being green, a positive b* being yellow and a negative b* being blue. Y in Table 3 designates the initial transmittance of the test article.

### EXAMPLE

the following example, plano PDQ coated polycarbonate lenses obtained from Gentex Optics were used. The test lenses were treated with an oxygen plasma for 1 minute using a Plasmatech machine at a power setting of 100 Watts while introducing oxygen at a rate of 100 ml/min into the vacuum chamber of the Plasmatech machine.

A photochromic master batch was prepared by mixing 25.2 grams of N-methyl pyrrolidinone and 2.28 grams (total) of 4 different naphthopyran photochromic compounds on a stir plate at 60° C. until the photochromic compounds were dissolved. The photochromic compounds were chosen and used in a ratio that yielded a gray color when the blend was exposed to ultraviolet light. The master batch also contained 1.13 grams of Tinuvin 144 UV stabilizer (hindered amine light stabilizer available from Ciba-Geigy); 2.52 grams of A-187 coupling agent (y-glycidoxypropyl trimethoxysilane available from OSi), and 0.04 grams of BYK-333 silicone surfactant (reported to be a polyether modified dimethyl polysiloxane copolymer available from BYK Chimie, USA.).

A photochromic polyurethane coating composition was prepared from the components and amounts tabulated in Table 1and mixed with the photochromic master batch. The mixture of the coating composition components were mixed for 60 minutes on a stir plate at room temperature before being applied to the plasma treated lenses by spin coating. The photochromic polyurethane coatings applied to the test lenses were thermally cured at 140° C. for 90 minutes in a convection oven. The photochromic polyurethane coatings were approximately 20 microns thick. One photochromic polyurethane coated lens was set aside (Sample E in Table 3) to serve as a performance reference.

TABLE 1
Formulation

| Component/ | Grams |
|---|---|
| Desmodur PL 3175A (a) | 6.3 |
| Vestanat B 1358A (b) | 26.5 |
| PC 1122 (c) | 25.0 |
| HCS 6234 polyol (d) | 5.9 |
| Dibutyltin dilaurate | 0.5 |
| Photochromic Master batch (e) | 31.2 |

(a) Methyl ethyl ketoxime blocked hexamethylene diisocyanate (Bayer)
(b) Methyl ethyl ketoxime blocked isophorone diisocyanate trimer (CreaNova, Inc.)
(c) Polyhexane carbonate diol (Stahl)
(d) Polyacrylate polyol (Composition D in Example 1 of U.S. Pat. No. 6,187,444 B1)
(e) A mixture in NMP of naphthopyran photochromic materials chosen to produce a gray tint when exposed to UV light.

One hundred (100) grams of distilled water was added to a wide-mouth jar and the jar placed in a triethylene glycol bath that was stirred magnetically and heated on a hot plate. The water was agitated vigorously with a Brookfield Counter Rotating Stirrer and 5.25 grams of Celvol 325 poly(vinyl alcohol) [available from Celanese] was added to the water. The temperature of the triethylene glycol bath was raised to 90° C. and the water/PVA mixture stirred vigorously for 30 minutes to form a clear solution. The jar containing the PVA solution was removed from the glycol bath and the solution allowed to cool to room temperature.

Three test solutions, each containing 10 grams of the PVA solution and a cross-linking agent, were prepared. Sample A contained 0.42 grams of Polycup® 172 cross-linking resin (a water-soluble polyamide-epichlorohydrin resin available from Hercules, Inc.); Sample B contained 0.14 grams of Polycup® 1884 cross-linking resin (a water-soluble polyamide-epichlorohydrin resin available from Hercules, Inc.); and Sample C contained 0.13 grams of glyoxal (CAS 107-22-2).

photochromic polyurethane coated test lenses were treated with an oxygen plasma for 1 minute using a Plasmatech machine at a power setting of 100 Watts while introducing oxygen at a rate of 100 ml/min into the vacuum chamber of the Plasmatech machine, and then separate test lenses were coated with one of the PVA test solutions by spin coating to obtain a wet film weight of approximately 0.025 grams. The PVA coated lenses were dried under an IR (infrared) lamp for 10 minutes. The IR lamp was placed at a distance from the lenses so that the temperature of the coating did not exceed 100° C.

The PVA coated lenses were then coated with an organic polymer tie layer prepared from the components tabulated in Table 2. The tie layers were applied by spin coating. The tie layer coatings had an approximate wet film weight of 0.05 grams, were cured in a nitrogen atmosphere with UV light from a D bulb, and then post cured for 3 hours at 100° C. in a convection oven.

One set of PVA/tie layer coated test lenses was tested for adhesion by use of the primary and secondary crosshatch tape peel adhesion tests, and all samples. passed this test. A second set of such lenses was tested for transmittance, residual bleach color, activated density and fading half-lives. Residual bleach color values were obtained using a Hunter Spectrophotometer and fade rate values were obtained using an optical bench. Photochromic migration is evidenced by an increase in the fade rate value, particularly the 3T ½ value. The data for photochromic response and fade rate tests is tabulated in Table 3. In this table, Sample D is a photochromic polyurethane coated lens that does not contain a PVA film coating, but has the tie layer coating. Sample E is the photochromic polyurethane coated lens that has no PVA coating or tie layer polymer coating, which was set aside to serve as a performance reference.

TABLE 2
Formulation

| Component/ | Grams |
|---|---|
| SR-399 (f) | 5.0 |
| BPA 2EO DMA (g) | 35.0 |
| TMPTMA (h) | 30.0 |
| ADME #302 (i) | 30.0 |
| BAPO (j) | 0.1 |
| A-187 (k) | 20.0 |
| CD-1011 (l) | 4.0 |

(f) Dipentaerythritol pentaacrylate (Sartomer)
(g) Bisphenol A (2EO) Dimethacrylate (Sartomer)
(h) Trimethylolpropane Trimethacrylate (Sartomer)
(i) Methacrylated Bisphenol A Epoxide (Echo Resins and Laboratory, Versailles, MO.)
(j) Bis(2,4,6-trimethyl benzoyl) phenyl phosphine oxide (Ciba Geigy)
(k) (γ-glycidoxypropyl trimethoxysilane available from OSi)
(l) Triarylsulfonium hexafluorophosphate salts mixed 50% in propylene carbonate (Sigma Aldrich)

TABLE 3

| | Initial Values¹ | | | | Fade Rate³ | | |
|---|---|---|---|---|---|---|---|
| Sample | Y | a* | b* | Photopic ΔOD² | T½ | 2T½ | 3T½ |
| A | 87.5 | −1.1 | 3.5 | 0.818 | 75 | 231 | 478 |
| B | 88.0 | −1.1 | 3.4 | 0.816 | 77 | 231 | 472 |
| C | 87.8 | −1.1 | 3.5 | 0.819 | 78 | 233 | 465 |
| D | 86.5 | −1.1 | 3.1 | 0.821 | 83 | 256 | 528 |
| E | 88.1 | −0.9 | 2.6 | 0.855 | 79 | 236 | 479 |

¹Initial transmittance (Y) and color (a* and b*) values.
²Change in optical density when exposed to UV light.
³The fade rates (in seconds) after activation at 72° F. (22° C.) for the lens to reach ½ the highest ΔOD (T½); for the lens to reach ½ of the interval between the ½ OD level and the highest ΔOD (2T½); and for the lens to reach ½ of the interval between the 2T½ OD level and the highest ΔOD (3T½) after removal of the source of activating light

The data of Table 3 show that the lenses with the cross-linked PVA film coating (Samples A, B and C) exhibit similar fading values to the performance reference lens (Sample E); while the lens without the cross-linked PVA film (Sample D) shows significantly higher fading values, particularly for the 2T½ and 3T½ values, which indicates slower photochromic fading and photochromic migration into the polymeric tie layer.

Although the present invention has been described with reference to specific details of certain embodiments thereof, it is not intended that such details should be regarded as limitations upon the scope of the invention except insofar as they are included in the accompanying claims.

1. A photochromic article comprising:
(a) a rigid substrate,
(b) a photochromic organic polymeric coating appended to at least a portion of at least one surface of said substrate, said photochromic coating comprising a photochromic amount of at least one photochromic material,
(c) a film comprising a cross-linked polyhydroxy polymer superposed on said photochromic organic polymeric coating, and
(d) a layer of transparent further organic polymer that is superposed on said film comprising a cross-linked polyhydroxy polymer.

2. The photochromic article of claim 1 wherein the polyhydroxy polymer is a natural, chemically modified natural or synthetic polyhydroxy polymer.

3. The photochromic article of claim 2 wherein the polyhydroxy polymer is poly(vinyl alcohol).

4. The photochromic article of claim 1 wherein the film comprising the cross-linked polyhydroxy polymer has a thickness of from 0.1 to 10 microns.

5. The photochromic article of claim 1 wherein an abrasion resistant coating is appended to the further organic polymer layer.

6. The photochromic article of claim 5 wherein the abrasion resistant coating is an organo silane-based abrasion resistant coating.

7. The photochromic article of claim 1 wherein the transparent rigid substrate is an organic polymeric substrate chosen from thermoset or thermoplastic materials having a refractive index of from 1.48 to 1.74.

8. The photochromic article of claim 7 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes or substrates prepared from compositions comprising the reaction product of polyfunctional isocyanate(s) and/or isothiocyanate(s) with polythiol(s) or polyepisulfide monomer(s).

9. The photochromic article of claim 8 wherein the allyl diglycol carbonate is diethylene glycol bis(allyl carbonate).

10. The photochromic article of claim 1 wherein the photochromic organic polymeric coating is chosen from photochromic polyurethane-based coatings, photochromic polyurea urethane-based coatings, photochromic poly(meth)acrylic-based coatings, photochromic aminoplast resin-based coatings, or photochromic epoxy resin-based coatings.

11. The photochromic article of claim 1 wherein the photochromic material is an organic photochromic material chosen from photochromic spirooxazines, benzopyrans, naphthopyrans, fulgides, metal dithizonates, diarylethenes or mixtures of such photochromic materials.

12. The photochromic article of claim 11 wherein the photochromic naphthopyran is chosen from naphtho[1,2-b]pyrans, naphtho[2,1-b]pyrans, spiro-9-fluoreno[1,2-b]pyrans, phenanthropyrans, quinopyrans or indeno-fused naphthopyrans, and the spirooxazine is chosen from naphthoxazines or spiro (indoline)pyridobenzoxazines.

13. The photochromic article of claim 5 wherein an antireflective coating is appended to said abrasion resistant coating.

14. The photochromic article of claim 13 wherein the photochromic article is a lens.

15. A photochromic article comprising:
(a) a rigid transparent substrate,
(b) a photochromic organic polymeric coating appended to at least a portion of said substrate, said photochromic coating comprising a photochromic amount of at least one organic photochromic material,
(c) a film comprising a cross-linked polyhydroxy polymer appended to said photochromic organic polymeric coating, and
(d) a layer of a transparent further organic polymer that is appended to said film comprising a cross-linked polyhydroxy polymer.

16. The photochromic article of claim 15 wherein the polyhydroxy polymer is chosen from chemically modified natural or synthetic polyhydroxy polymers.

17. The photochromic article of claim 16 wherein the synthetic polyhydroxy polymer is chosen from poly(vinyl alcohol), or polymers prepared from polymerizable compositions comprising the materials 2-hydroxyethyl methacrylate, 2-hydroxypropyl acrylate, 2-hydroxypropyl methacrylate, 2,4-dihydroxy-4-vinyl benzophenone, N-2-hydroxyethyl acrylamide, N-2-hydroxyethyl methacrylamide and mixtures of such materials.

18. The photochromic article of claim 17 wherein the degree of hydrolysis of the poly(vinyl alcohol) ranges from 75 to 99.8 percent.

19. The photochromic article of claim 15 wherein an abrasion resistant coating is appended to said further organic polymeric coating.

20. A photochromic article comprising:
(a) a rigid transparent substrate, said substrate being an organic polymeric substrate chosen from thermoset or thermoplastic materials, said substrate having a refractive index of from 1.48 to 1.74,
(b) a photochromic organic polymeric coating appended to at least a portion of said substrate, said photochromic coating comprising a photochromic amount of at least one organic photochromic material,
(c) a film comprising a cross-linked polyhydroxy polymer appended to said photochromic organic polymeric coating, and
(d) a layer comprising a transparent further organic thermoset polymer that is appended to said film comprising a cross-linked polyhydroxy polymer.

21. The photochromic article of claim 20 wherein the organic polymeric substrate is a substrate chosen from thermoset substrates prepared from polymerizable compositions comprising allyl diglycol carbonate monomer(s), substrates prepared from thermoplastic polycarbonates, substrates prepared from polyurea urethanes and substrates prepared from compositions comprising the reaction product of polyfunctional isocyanate(s) and/or isothiocyanates with polythiol or polyepisulfide monomer(s).

22. The photochromic article of claim 21 wherein the photochromic organic polymeric coating is chosen from photochromic polyurethane-based coatings, photochromic polyurea urethane-based coatings, photochromic poly(meth)acrylic-based coatings, photochromic aminoplast resin-based coatings, or photochromic epoxy resin-based coatings.

23. The photochromic article of claim 22 wherein the transparent further organic polymeric layer (d) is a radiation cured acrylic-based polymer.

24. The photochromic article of claim 23 wherein an abrasion resistant coating is appended to the transparent further organic polymer layer (d).

25. The photochromic article of claim 24 wherein the abrasion resistant coating is an organo silane-based abrasion resistant coating.

26. The photochromic article of claim 24 wherein an antireflective coating is appended to the abrasion resistant coating.

27. The photochromic article of claim 24 wherein the article is a lens.

28. The photochromic article of claim 26 wherein the article is a lens.
